(19) United States
(12) Patent Application Publication
(10) Pub. No.: US 2022/0406208 A1
(43) Pub. Date: Dec. 22, 2022

(54) SYSTEMS AND METHODS FOR ADAPTIVE GOAL-ORIENTED LEARNING PATHS

(71) Applicant: Gooru, Inc., Redwood City, CA (US)

(72) Inventor: Prasad Ram, Los Altos, CA (US)

(73) Assignee: Gooru, Inc., Redwood City, CA (US)

(21) Appl. No.: 17/879,807

(22) Filed: Aug. 3, 2022

Related U.S. Application Data
(63) Continuation-in-part of application No. 16/004,690, filed on Jun. 11, 2018, now abandoned.
(60) Provisional application No. 62/643,639, filed on Mar. 15, 2018.

(51) Int. Cl. G09B 5/02; G09B 5/04; G06F 16/9535

(52) U.S. Cl. CPC G09B 5/02; G09B 5/04; G06F 16/9535

(57) ABSTRACT

Disclosed herein are system, method, and computer program product embodiments for providing adaptive learning paths based on specified learning goals and student competency. An embodiment operates by receiving a learning objective associated with a user and retrieving from one or more storage devices a competency profile associated with the user. The competency profiles comprise information representing a current competency of the user regarding concepts associated with the learning objective. Then system then selects, based on a concept dependency graph, an ordered set of learning activities that establish a path between the current proficiency and the learning objective. References to the learning activities are stored in a learning activities table associated with the concepts in the concept dependency graph. The system then sends information related to the learning activities to the user.

### CROSS-REFERENCE TO RELATED APPLICATIONS SECTION

This Application is a U.S. Non-Provisional Patent Application and Continuation-in-Part (CIP) of U.S. Non-Provisional patent application Ser. No. 16/004,690 filed on Jun. 11, 2018, which claims priority from U.S. Provisional Patent Application Ser. No. 62/643,639 filed on Mar. 15, 2018, the entire contents of which are hereby incorporated by reference in their entirety.

### FIELD OF THE EMBODIMENTS

The field of the invention and its embodiments relates to computerized educational systems and methods.

### BACKGROUND OF THE EMBODIMENTS

Traditionally, education has focused on the learning “destination.” Teachers teach courses according to established curricula and standards set by government agencies or educational institutions. Students take exams and complete assignments to assess their mastery of the subject matter, again as directed by established standards. In general, educational standards are met via two main activities. First, learning occurs in a classroom environment where multiple students learn along the same path and at the same pace, with the ability to interact and support each other. Second, learning activities are typically well-structured in textbooks or a variety of online applications/courses. Well-structured mechanisms for learning have allowed students to manage their pace, interact with a community, and even adapt the content based on learner's performance. However, while these fixed-path approaches have served a fortunate few, they have fallen short for the majority of people.

### SUMMARY OF THE EMBODIMENTS

Disclosed herein are system, method, and computer program product embodiments for providing adaptive learning paths based on specified learning goals and student competency profiles. An embodiment operates by receiving a learning objective associated with a user and retrieving a competency profile associated with the user. The competency profile includes information representing a current proficiency of the user regarding concepts associated with the learning objective. Based on a concept dependency graph, the system determines an ordered set of learning activities that establish a path between the current proficiency and the learning objective. The user is then presented with information related to the learning activities.

### BRIEF DESCRIPTION OF THE DRAWINGS

The accompanying drawings are incorporated herein and form a part of the specification.

FIG. 1 illustrates an educational system environment, according to an example embodiment.

FIG. 2 is a flowchart of a method for providing adaptive learning paths based on specified learning goals and student competency profiles, according to an example embodiment.

FIG. 3 is a flowchart of a method for providing suggestions and assessments for generating adaptive learning paths, according to an example embodiment.

FIG. 4 is a block diagram describing a subject matter competency model, according to an example embodiment.

FIG. 5 is a block diagram describing the generating and presentation of suggestions and route planning for an adaptive learning path, according to an example embodiment.

FIG. 6 is a diagram describing a concept competency map, according to an example embodiment.

FIG. 7 shows a user interface for gathering competency profile data, according to an example embodiment.

FIG. 8 shows a user interface for navigating an educational content portal, according to an example embodiment.

FIG. 9 shows a user interface for navigating educational content offerings and learning routes, according to an example embodiment.

FIG. 10 shows additional details of a user interface for navigating educational content offerings and learning routes, according to an example embodiment.

FIG. 11 shows additional details of a user interface for navigating educational content offerings and learning routes, according to an example embodiment.

FIGS. 12A and12B show example user interfaces for accessing adaptive learning routes, according to an example embodiment.

FIGS. 13A and 13B show example user interfaces for tracking progress of an adaptive learning route, according to an example embodiment.

FIG. 14 shows a user interface for managing content preferences of an adaptive learning route, according to an example embodiment.

FIG. 15 shows a user interface for refining an adaptive learning route, according to an example embodiment.

FIG. 16 shows a user interface for receiving suggestions for learning resources and routes, according to an example embodiment.

FIGS. 17A and 17B show example user interfaces for viewing a concept proficiency matrix, according to an example embodiment.

FIG. 18 shows a user interface for communicating and sharing content with other users of a learning environment, according to an example embodiment.

FIG. 19 shows further details of user interface for communicating and sharing content with other users of a learning environment, according to an example embodiment.

FIG. 20 shows a user interface related to learning performance, according to an example embodiment.

FIGS. 21A and 21B show example user interfaces for providing an assessment of concept proficiency, according to an example embodiment.

FIGS. 22A and 22B show example user interfaces displaying complete competency proficiency for a subject with student's mastery of the competencies, according to an example embodiment.

FIG. 23 shows a user interface showing a course view displaying the complete competency proficiency for a subject with student's mastery of the competencies by taxonomy course, according to an example embodiment.

FIG. 24 illustrates a user interface showing a comparative view of domain proficiency in a cohort of learners, according to an example embodiment.

FIG. 25 shows a user interface providing a suggested route for target destination competency for a learner, according to an example embodiment.

FIG. 26 shows a user interface for providing reroute suggestions, according to an example embodiment.

FIG. 27 shows a matrix view of the competency model for a subject, according to an example embodiment.

FIG. 28 is an example computer system useful for implementing various embodiments.

FIG. 29 depicts a schematic diagram of the interactions between a third-party content and tools provider, a navigator engine, and an institution, according to at least some embodiments disclosed herein.

FIG. 30 depicts a schematic diagram depicting how route planning occurs to move the user from a current competency to a desired competency, according to at least some embodiments disclosed herein.

FIG. 31 depicts an illustrative diagram of a navigator engine ecosystem, according to at least some embodiments described herein.

FIG. 32 depicts a schematic diagram of system architecture, according to at least some embodiments described herein.

FIG. 33 depicts another schematic diagram of system architecture, according to at least some embodiments described herein.

FIG. 34 depicts a schematic diagram of Navigator Core, according to at least some embodiments disclosed herein.

FIG. 35 depicts a schematic diagram of the system set up as a scalable and a high availability (HA) cluster, according to at least some embodiments disclosed herein.

FIG. 36 depicts a schematic diagram of several components of the system, including a Kafka Persistent Message Bus, according to at least some embodiments disclosed herein.

FIG. 37 depicts another schematic diagram of several components of the system, including a Kafka Persistent Message Bus, according to at least some embodiments disclosed herein.

FIG. 38 depicts a schematic diagram associated with a method executed by the system, according to at least some embodiments disclosed herein.

FIG. 39 depicts another system diagram, according to at least some embodiments described herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

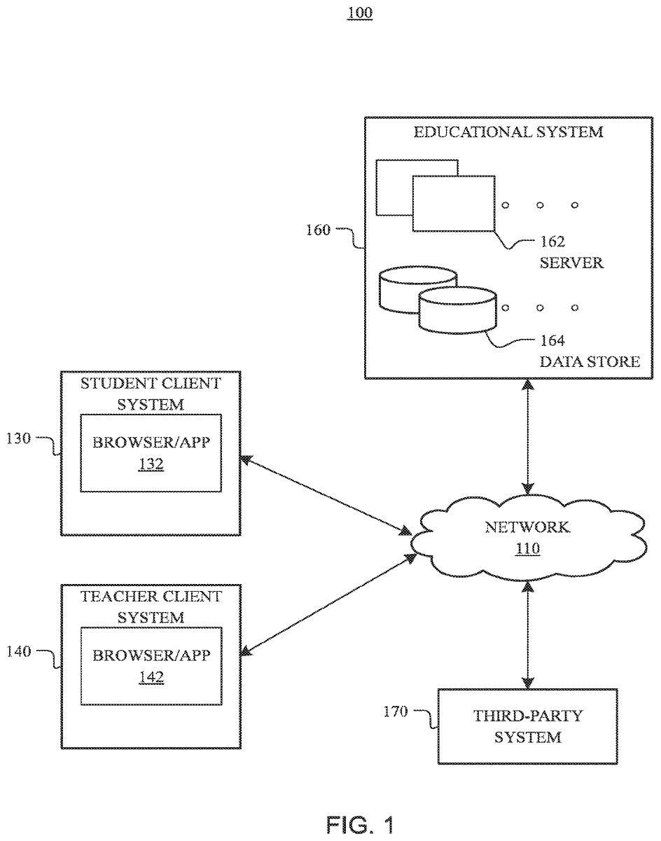

FIG. 1 illustrates an educational system environment 100, according to an example embodiment. A student client system 130 and a teacher client system 140 connect to each other and to educational system 160 through a network 110. The network may be any communications network suitable for transmitting data between computing devices, such as, by way of example, a Local Area Network (LAN), a Wide Area Network (WAN), Metropolitan Area Network (MAN), Personal Area Network (PAN), the Internet, wireless networks, satellite networks, overlay networks, and the like, or any combination thereof. Student client system 130 and teacher client system 140 may be any computing device suitable for interacting with educational system 160, such as, by way of example, a personal computer, mobile computer, laptop computer, mobile phone, smartphone, personal digital assistant, tablet computer, or the like. Educational system 160 may be any computing device or combination of devices suitable to provide online interfaces, such as, by way of example, server computers, database systems, storage area networks, web servers, application servers, or the like, or any combination thereof. As an example, one or more servers 162 may store and access data from one or more data stores 164, and may further communicate with one or more clients 130 and 140 to serve requests and generate a graphical user interface for display in client devices 130 and 140.

Users of client systems 130 and 140 may interact with educational system 160 through any suitable graphical user interface 132, 142, such as, by way of example, an application, web browser, web application, mobile application, etc. Each user may establish an account and profile with educational system 160. Additionally, educational system 160 may redirect clients 130, 140 to access content from one or more third-party systems 170. As an example, educational system 160 may provide clients 130, 140 links or may display media hosted by a third-party system 170.

Educational system 160 may provide a plurality of interfaces for various user types. For example, a student may use a learner interface 132 for navigating educational offerings, generating learning routes, and consuming educational content, among other things, as described throughout. A teacher may use a teacher interface 142 for interacting with students, reviewing student progress, creating learning resource collections, among other things.

Educational system 160 may further provide Application Programming Interfaces (APIs) for creating educational experiences for other users. The information, metadata, taxonomies and concept graphs described throughout this disclosure can be specified by API users. As an example, an educational institution (e.g., School, University, Community College, etc.) may use educational system 160 to create learning journeys, courses, units, lessons, collections, and other learning constructs as described throughout this disclosure. API users may provide resources and assessments, or associated resources and assessments made available by educational system 160 with their courses. In addition, API users may specify taxonomy information specifying pre-requisites for the educational content provided, and educational standards information specifying what educational standards the content is meant to satisfy. In this manner, educational institutions may benefit from the functionalities of educational system 160, such as adaptive learning path generation, suggestion solicitation, supplementary resources tools and resources, etc., as will be described throughout this disclosure.

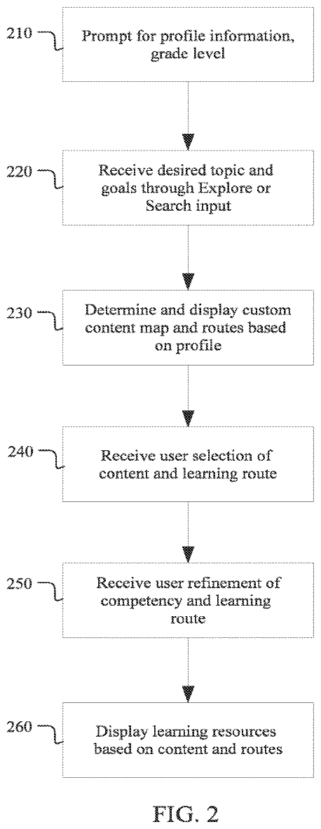

FIG. 2 is a flowchart of a method for providing adaptive learning paths based on specified learning goals and student competency profiles, according to an example embodiment.

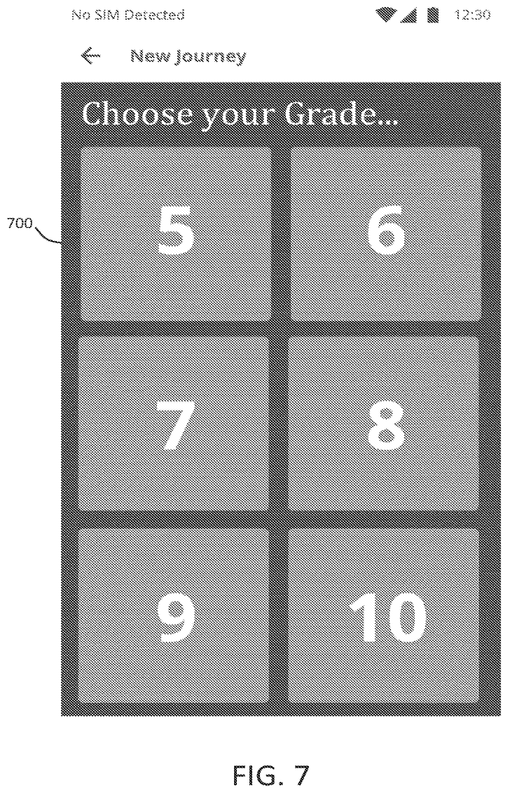

At step 210, educational system 160 obtains profile information about a learner, for example, by prompting the learner to input relevant information. Educational system 160 may also obtain the profile information from other sources, such as associated social-networking profiles, school information, etc. As shown in FIG. 7, a K-12 student may input the grade level the student is currently in. Once a learner has completed the user profile, the learner can navigate the rest of the application. Educational system 210 may then use profile information to select appropriate educational content to offer the learner.

At step 220, educational system 160 may receive information related to desired educational topics or goals of the learner, for example, through its user interface. In particular embodiments, the interface may show a search bar for entering topics of interest. A search bar may provide autocompletion suggestions based on educational contents available for the user and the user competency profile. In particular embodiments, a user interface may allow a user to browse through available topics through a navigation interface.

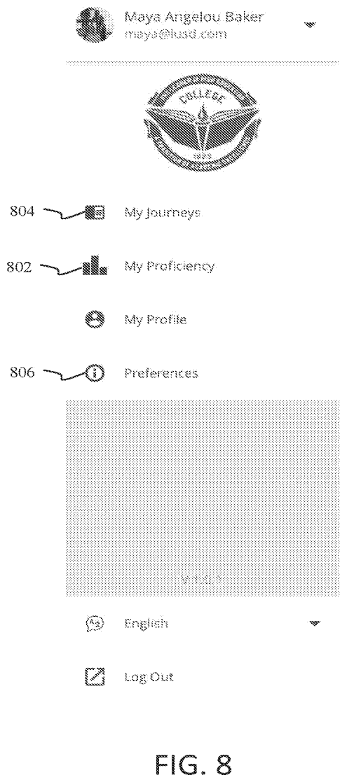

FIG. 8 shows a user interface for initiating navigation of an educational content portal, according to an example embodiment. In particular embodiments, a learner may navigate to a Proficiency Section 802, a Journeys Section 804, and a Preferences Section 806. Proficiency Section 802 may provide various progress and competency metrics associated with the user based on, for example, completion of learning activities, assessment scores, etc. Journeys Section 804 may provide interfaces to navigate learning offerings, create learning paths, and consume learning content. Preferences 806 may provide various customizable settings, such as specifying the type of learning experiences the user prefers. At step 230, educational system 160 determine and display customized content map and routes based on profile. The content selected for display may be based on the learner's competency profile and analytics based on user data including, by way of example, assessment performance, educational activities completed, educational standards, etc. Educational system 160 may access a concept dependency graph and locate the user's current competency in the graph based on the user's competency profile. Educational system 160 may then find one or more paths from the user's current competency to the learning objective, and present them to the user.

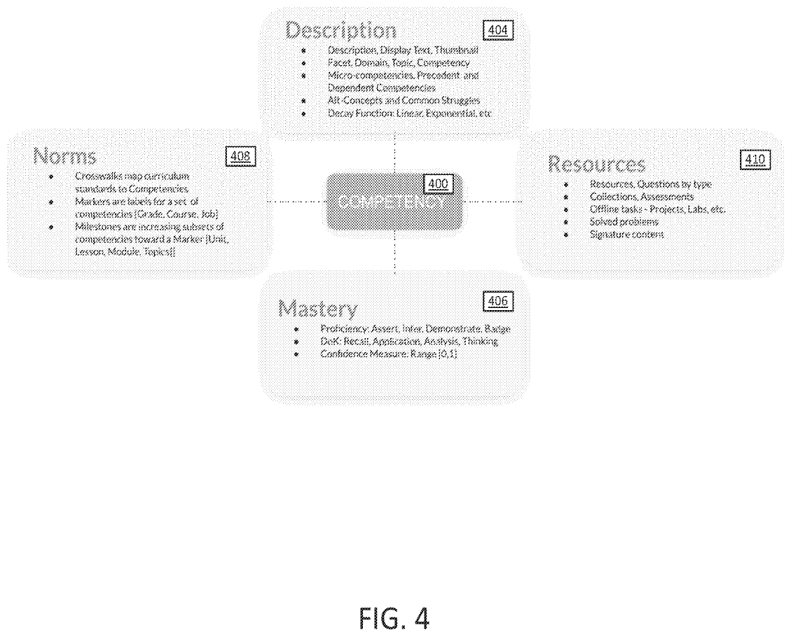

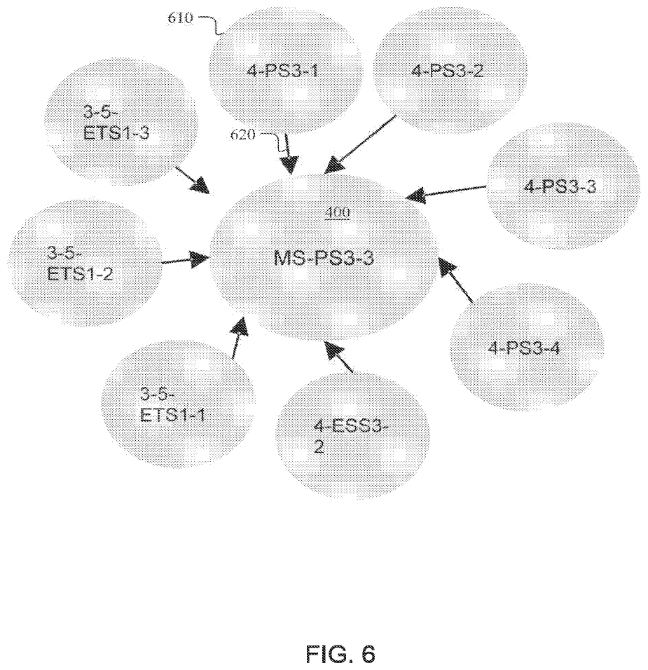

FIG. 4 a block diagram of a subject matter competency model, according to an example embodiment. Educational system 160 may maintain a database of competencies with information on various subject matters. The information may allow educational system 160 to properly generate content suggestions and learning routes for learners. A competency 400 may include a Description 404 of the subject matter that the competency describes. A competency 400 may further include Mastery information 406 that indicates whether a learner is competent in the subject matter, and what the requirements are to become competent. In particular embodiments, a competency may be associated with a progression of prerequisites or other dependencies that describes what other competencies (if any) a learner should have completed before completing competency 400. In this manner, the competencies form a directed graph describing possible progressions to complete a competency, as illustrated in FIG. 6. A competency 400 may be associated with multiple other competencies 610 with a prerequisite relationship 620, indicating that the competencies 610 must be completed before completing competency 400.

A competency 400 may be associated with educational resources 410 (e.g., questions, collections, assessments, etc.) that aid in the learning of the subject matter. Mastery information 406 may be measured and recorded for the learner based on any suitable metrics, such as proficiency including assertions, inferences demonstrations, badges earned, etc.

A competency 400 may also be associated with multiple educational Norms. In embodiments, educational system 160 may generate a crosswalks table that maps curriculum standards from multiple sources to competencies in the competency database. Mapping multiple standards to a competency may aid in identifying relevant learning resources. As an example, educational system 160 may receive profile information describing a user as an 8^{th} grade student from California. The system 160 may search the competency database to identify competencies associated with California educational standards, finding, as an example, 8^{th} grade Earth Science competency in the competency database. System 160 may then identify in the standards table 408 other educational standards associated with the same competency (e.g., Texas standards for 8th grade Earth Science). In this manner, educational system 160 may aggregate sources tagged as complying with corresponding standards and offer additional relevant educational resources to learners and teachers operating under different standards. In particular embodiments, educational system 160 may calculat3 a 3-tuple representing the subject competency information for the user, the 3-tuple including a value representing the subject, a value representing the one or more domains, and a value representing the one or more courses. The 3-tuple representation may be part of the user's competency profile. Analogously, a learning objective associated with the user is also represented as a 3-tuple of a desired subject competency. In essence, the 3-tuples comprise a point in a 3-dimensional space, each point in the space representing an educational state. In this manner, educational system 160 may perform route planning to move the user from the current competency to a desired competency by finding a route between the two points in this 3-dimensional space. For example, based on the concept dependency graph, as described herein, educational system 160 may generate an ordered set of learning activities that establish a path between the subject competency 3-tuple and the learning objective 3-tuple.

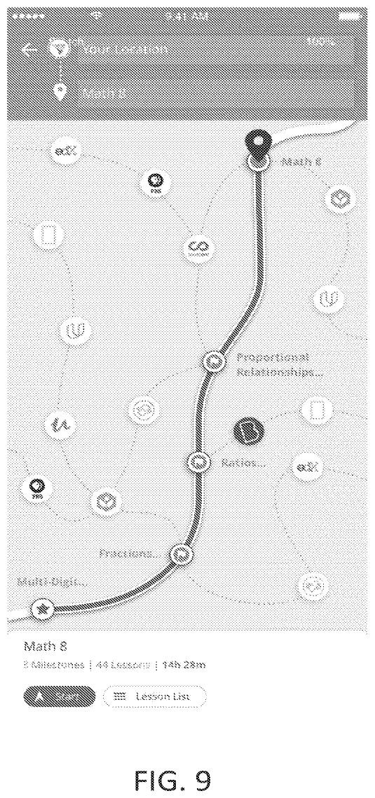

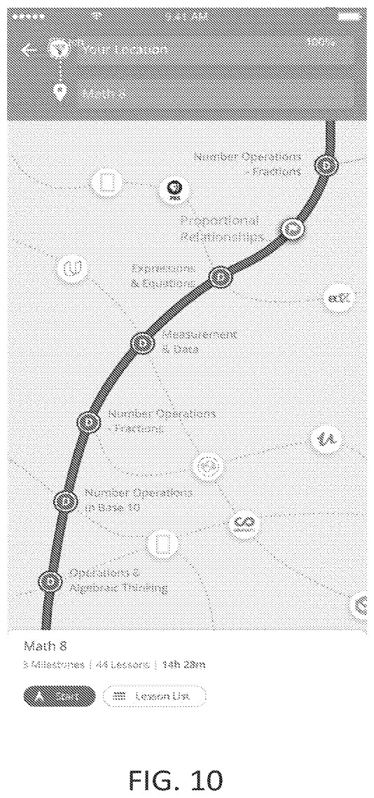

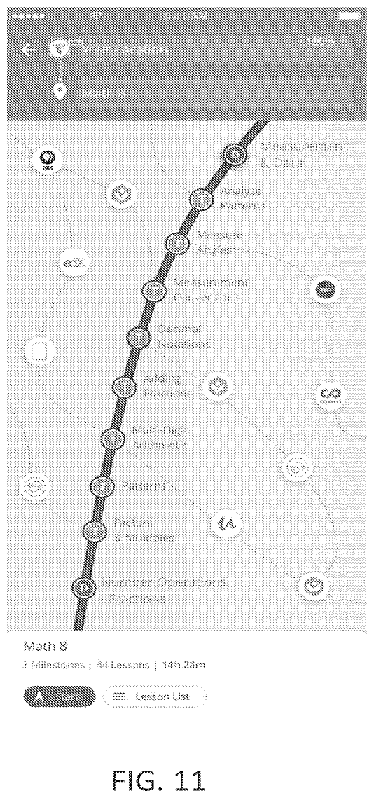

FIGS. 9-11 show a map interface for navigating an educational content portal, according to an example embodiment. In particular embodiments, educational system 160 may provide a map interface showing available content and dependencies among the content. As an example, a user interface may show available courses based on a user competency profile of an eight-grade student (e.g., Math, Earth Science, Biology, Environmental Science, etc.). The interface may further include a zooming mechanism and zoom label. In particular embodiments, zooming into the map may dynamically reveal details of each available course. As shown in FIG. 9 for example, a Math 8 course may comprise multiple units, e.g., multi-digit problems, fractions, ratios, proportional relationships, etc. As the user zooms more and more into the map, additional details of each educational component may be revealed. For example, FIG. 10 shows revealed components including operations and algebraic thinking, number operations in base 10, fractions, measurements and data, expressions and equations, proportional relationships, etc. Furthermore, the map interface may show dependencies between educational components through paths. For example, FIG. 11 sows an example visual route line that communicates a student should study a Factors and Multiples unit first, then a Patterns unit second, followed by a Multi-Digit Arithmetic unit third, etc. Furthermore, zooming into the map may provide additional details such as images associated with certain educational components.

As the map is further zoomed in, images associated with parent components may disappear and images related to child components may appear. In this manner, educational concepts of lower granularity may be shown, e.g., courses composed of units, units composed of lessons, lessons composed of resources, etc. As shown in FIGS. 9-11, a Math 8 course may contain a Fractions unit, which in turn may include a Number Operations lesson, which in turn may contain Factors & Mutiples, Patterns, etc. resources. Resources may include any relevant educational resource for learning, such as, by way of example, video lectures, audio lectures, documentaries, podcasts, textbook readings, quizzes, articles, etc. Resources may be provided through the educational system interface directly, or via a referral such as a link to third-party resources (e.g., Khan Academy, Math Central, Wikipedia, etc.).

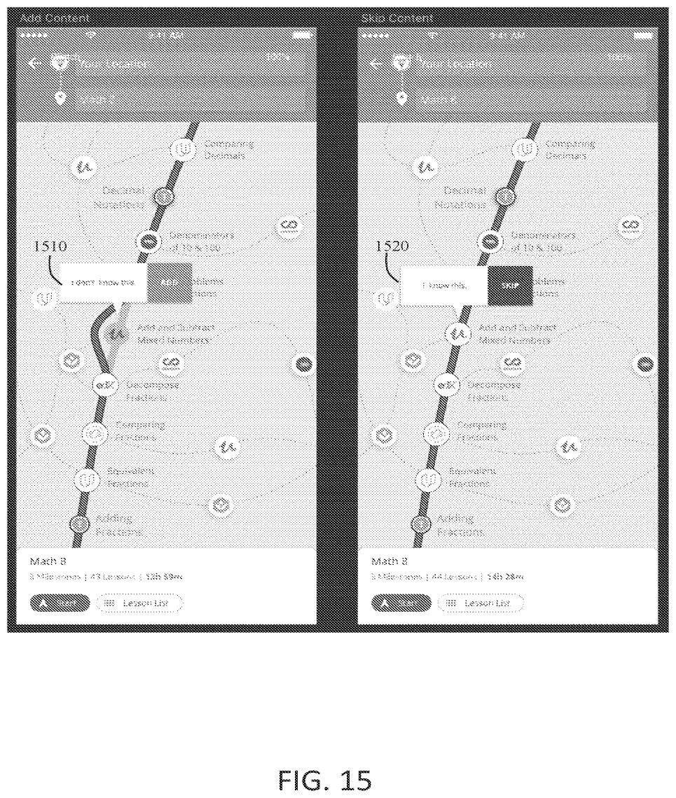

At step 240, educational system 160 receives user selection of content and learning routes. System 160 may receive selections through the navigation interface, the search interface, or any other suitable means. As an example, a student may browse the map interface and select a one or more of the courses or collections displayed. In particular embodiments, a user may select a learning destination, i.e., a competency that the user wishes to complete. Educational system 160 may then suggest a route for the user to achieve the desired competency. For example, a user interface may show a list of resources showing an adaptive learning route, according to an example embodiment. FIG. 15 shows a map view interface showing an adaptive learning route, according to an example embodiment.

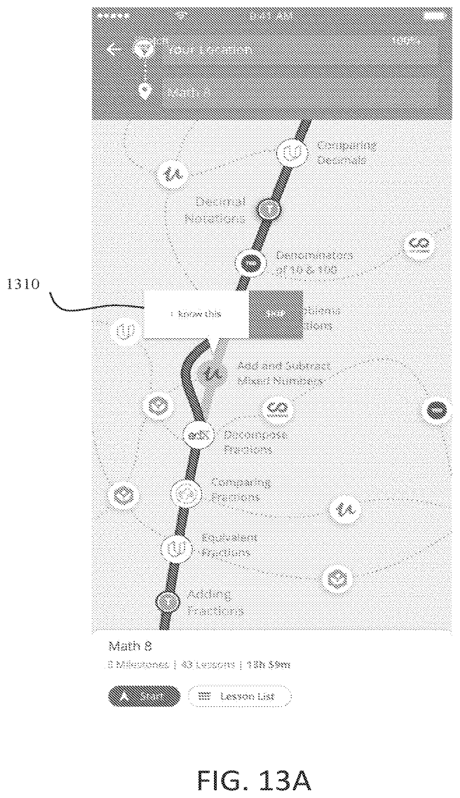

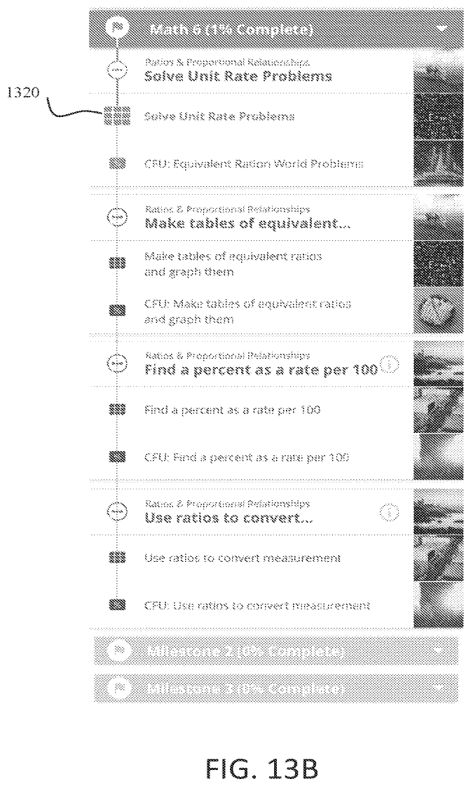

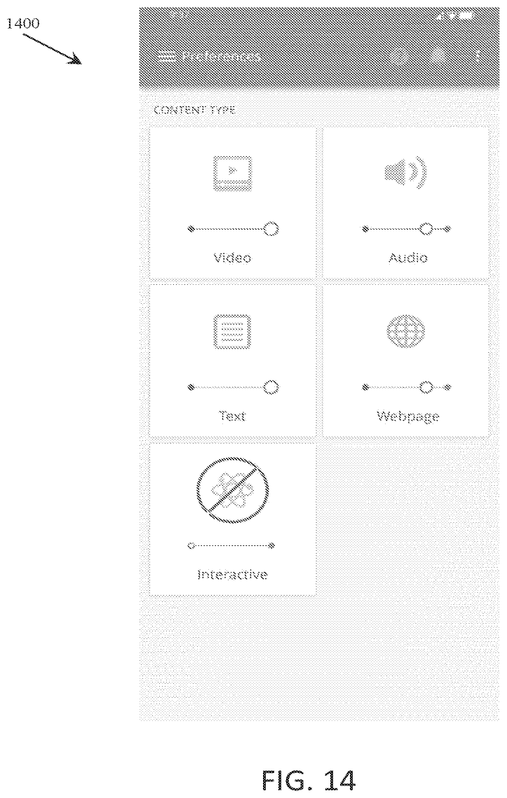

At step 250, educational system 160 receives user refinement of competency and learning routes. As shown in FIGS. 13A, 13B, a user may adjust the learning route by adding or removing points along the route. For example, a user may indicate in an interface that the user is already familiar with a unit and is competent in the subject matter, as shown in FIG. 13A, element 1310 for a map interface and FIG. 13B, element 1320 for a list-view interface. In another example, a user may add points along the route or change points to create an alternate route, as shown in FIG. 15, 1510 on a map interface. In this manner, the map interface allows the user to easily visualize multiple alternate courses/units/lessons that can be completed to become competent in a particular subject matter.

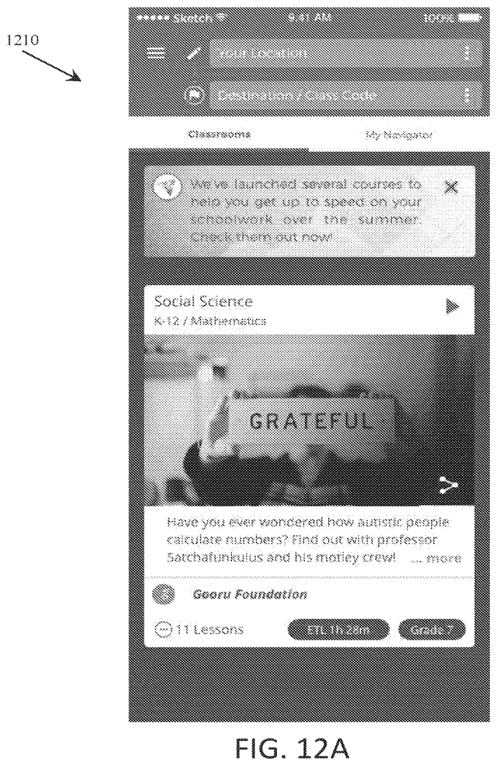

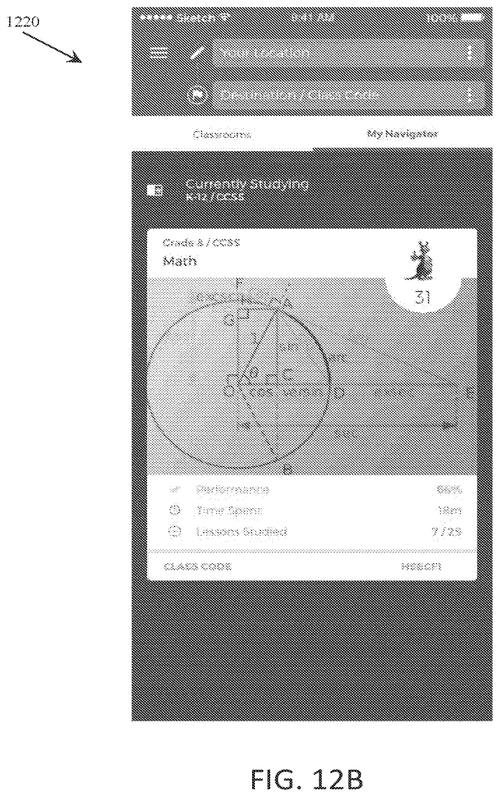

At step 260, educational system 160 offers learning resources based on the user's selected route. FIGS. 12A and 12B show user interfaces for accessing learning journeys based on selected routes, according to an example embodiment. In FIG. 12A, a user interface 1210 shows an interface containing information, where a user has yet to select a route. In FIG. 12B, interface 1220 shows a resource for use in a Math 8 course, along with information related to completion and current state of the journey in that course.

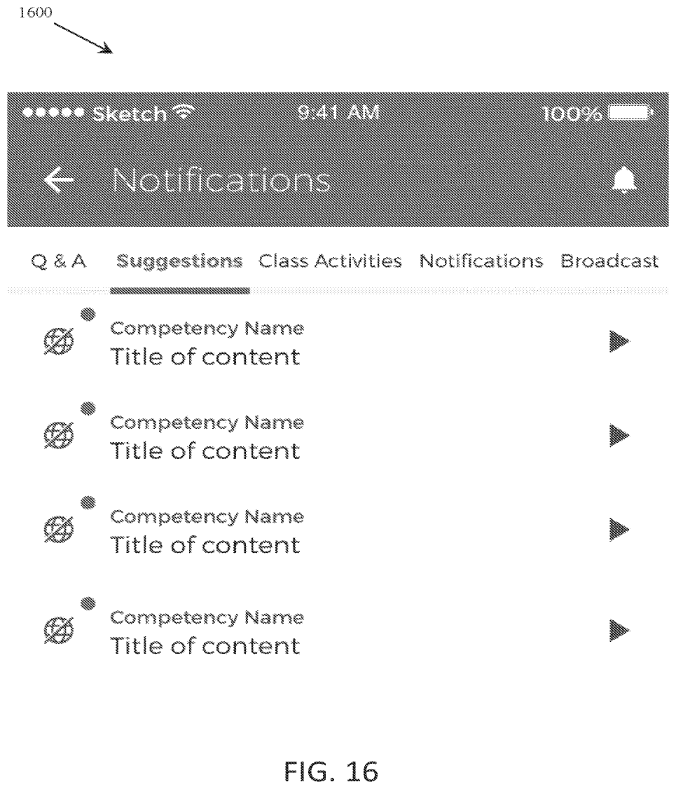

Educational system 160 may further offer suggestions to users for additional or complementary learning based on the user's competency profile. FIG. 16 shows an interface for presenting suggestions for class activities, notifications, and broadcasts, according to an example embodiment. Suggestions may be specific to a user based on their competency profile or general suggestions, for example.

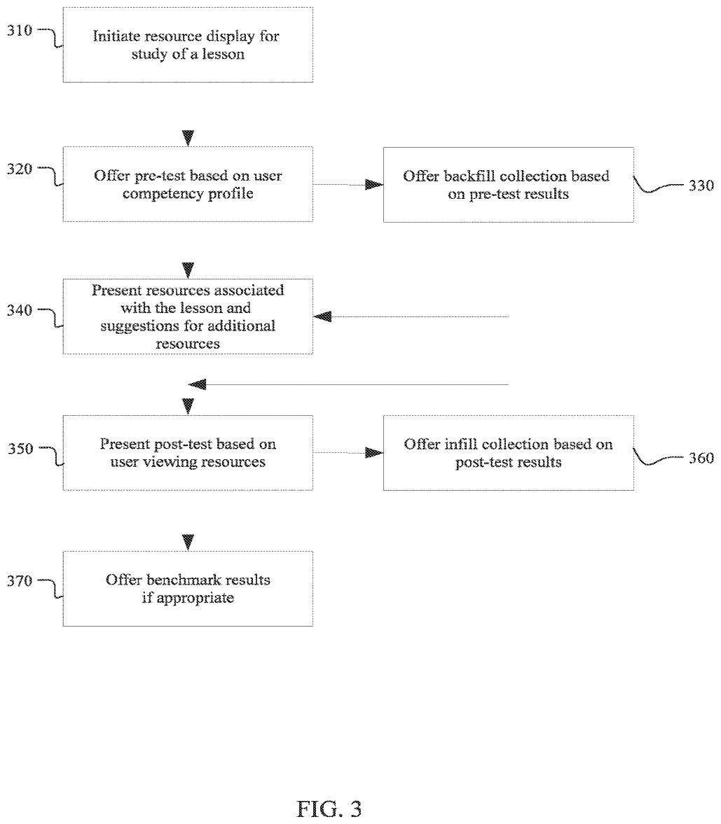

FIG. 3 is a flowchart of a method for providing suggestions and assessments for generating adaptive learning paths, according to an example embodiment. At step 310, educational system 160 initiates resource display for study of a lesson in response to a user input. At step 320, educational system 160 may offer one or more pre-tests based on a user competency profile. As an example, a pre-test may be offered that tests whether the user has a sufficient understanding of pre-requisite subject matter to continue studying the selected content. If the pre-test results indicate the user does not have the sufficient understanding, at step 330 educational system 160 offers one or more backfill collections of resources that provides the relevant learning. At step 340, educational system 160 presents resources associated with the lesson and suggestions for additional resources. Learners may elect to study additional related content along their personalized learning path. At step 350 educational system 160 presents one or more post-tests related to the subject matter visited. At step 360, educational system 160 offers an infill collection based on post-test results. As an example, educational system 160 may determine the user performed unsatisfactorily on a particular topic included in a post-test, and based on that offer a collection of resources associated with the topic. At step 370, educational system 160 offers results, such as, for example, a score and benchmarks comparing the learner performance to other learners.

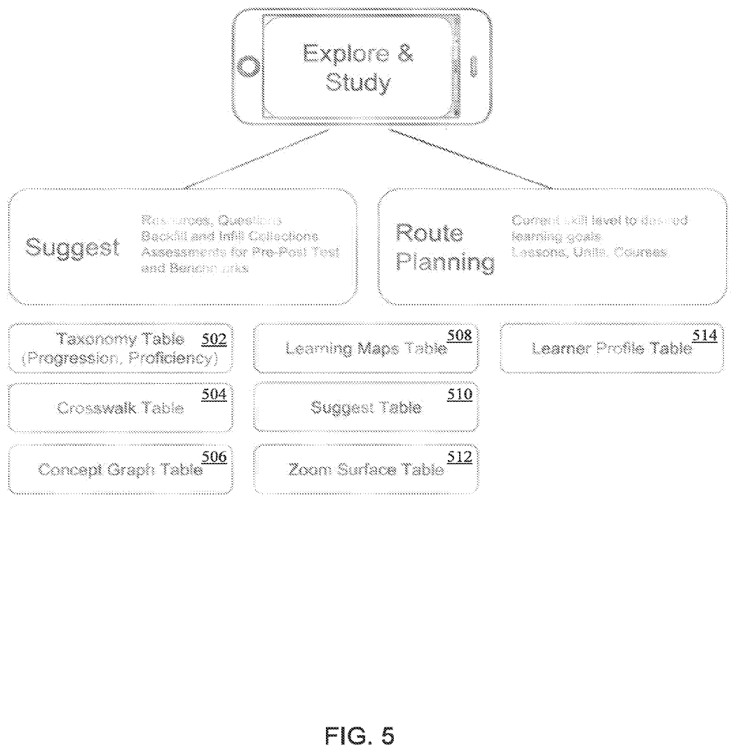

As explained above with reference to FIGS. 2 and 3, educational system 160 determines what content to present and suggest based on a user's competency profile. FIG. 5 is a block diagram describing the generation and presentation of suggestions and route planning for an adaptive learning path, according to an example embodiment. Educational system 160 may determine content to present and suggest based on information from some or all of taxonomy table 502, a crosswalk table 504, a concept graph table 506, learning maps table 508, suggest table 510, zoom surface table 512, and learner competency profile 514. Taxonomy table 502 contains hierarchical information describing topics and subject matter of an educational context.

As an example, taxonomy table 502 may contain concepts taught during K-12 education in a taxonomy that goes from Grade>Courses>Units>Lessons. In another example, a university may generate a taxonomy table 502 with a hierarchy that goes from Degree>Major>Courses>Units>Lessons. Crosswalk table 504 may include information that correlates standards across multiple educational entities. As an example, crosswalk table 504 may crosswalk the educational standards of all 50 states in the United States and align them with the taxonomy in taxonomy table 502. In this manner, educational system 160 can present content and suggestions that are relevant to learners adhering to any particular educational standard.

Moreover, as described herein, the crosswalk table 504 “crosswalks” the educational standards of all 50 states in the United States and aligns them with the taxonomy in taxonomy table 502. The crosswalks are developed using experts. Every competency has the associated state standards mapped to it in the crosswalk table 504. For some competencies, it is likely that there is no corresponding state standard for some states, in which case that cell is left blank.

Concept graph table 506 may store a graph describing the relationships between concepts. As an example, concept graph table 506 may store dependencies between concepts to create a graph that links concepts with their prerequisite concepts. It should be appreciated that concept graphs are maintained by having every competency be associated with the dependent competencies. The dependency graph is computed by traversing the competency-dependency information.

Learning maps table 508 and zoom surface table 512 may store information for generating the maps interface. As an example, learning maps table 508 may contain information associated with the content of map tiles based on the user's competency profile and topic of interest. Zoom surface table 512 may contain information on the granular content at various zoom levels. Suggest table 510 may contain further information needed to make suggestions. As an example, suggest table 510 may link to alternate resources for supplemental learning, record adoption of previous suggestions, etc.

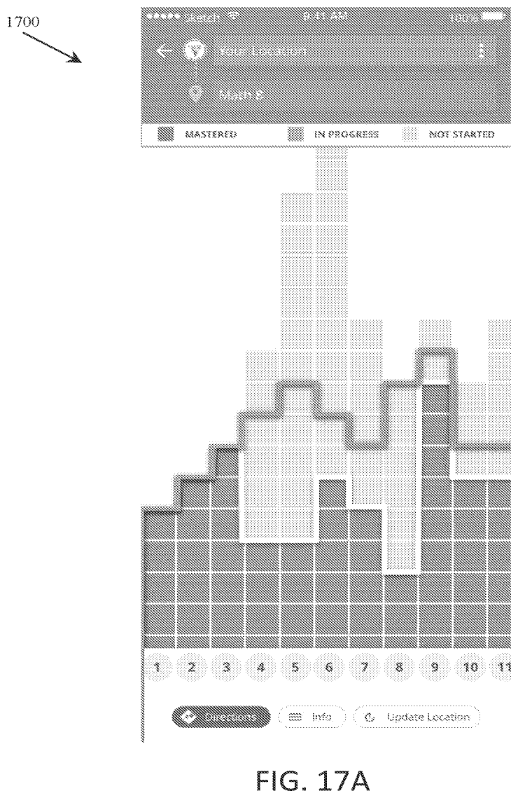

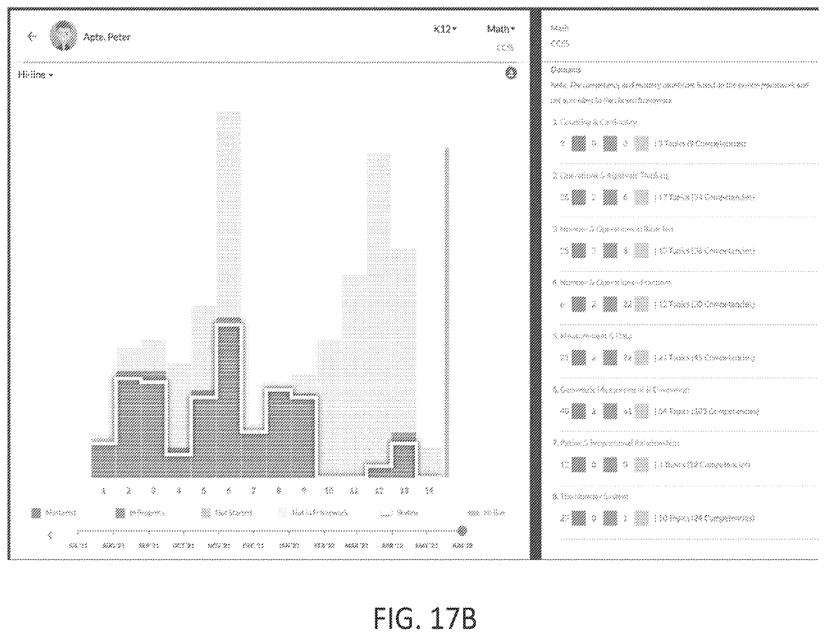

FIGS. 17A and 17B show user interfaces for viewing a concept proficiency matrix, according to an example embodiment. In particular embodiments, educational system 160 may present a learner with various interfaces for evaluating his/her performance. As an example, a Proficiency section 802 of the application may display an interface 1700 showing the learner's progress in various competencies. In the example shown, a competency matrix shows a status of “Mastered,” “In Progress,” or “Not Started” for various competencies and topics. A vertical axis may correspond to the level of competency in the K-12 context (e.g., 7^{th} grade, 8^{th} grade, etc.) while the horizontal axis may correspond to various subject matters or topics. FIG. 17B is another user interface that may be used in conjunction with or as an alternative to the interface shown in FIG. 17A.

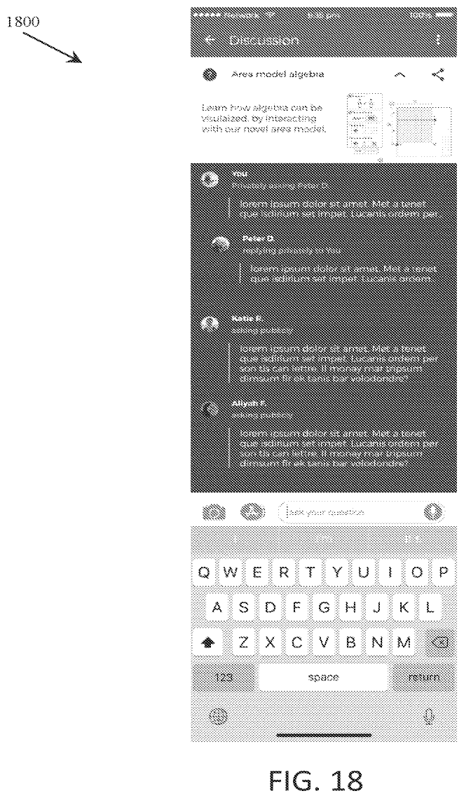

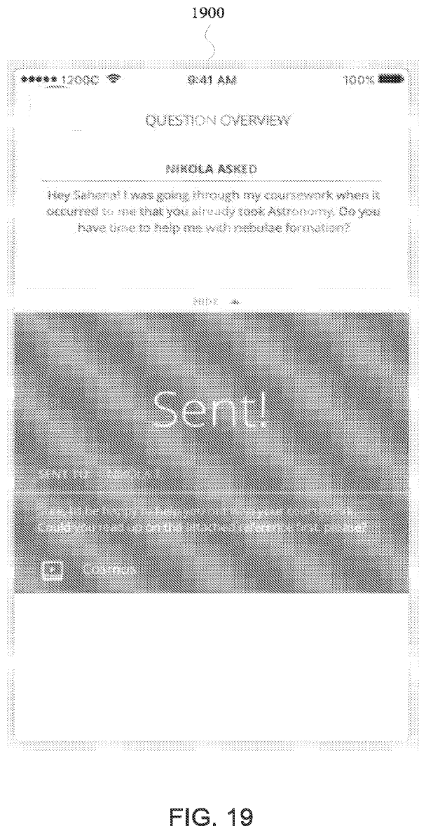

FIG. 18 shows a user interface 1800 for communicating and sharing content with other users of a learning environment, according to an example embodiment. In particular embodiments, educational system 160 may provide personalized suggestions for engagement between students, colleagues, and teachers. As an example, a learner may send messages to or receive messages from other learners or teachers. Educational system 160 may provide content or resource suggestions based on an analysis of the messages and the user competency profiles. Learners or teachers may also share the suggestions with each other, as shown in FIG. 19.

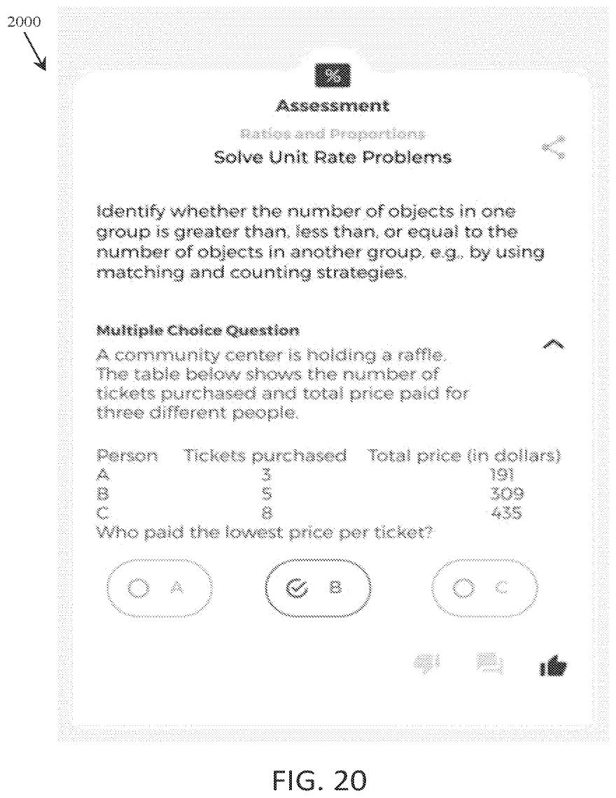

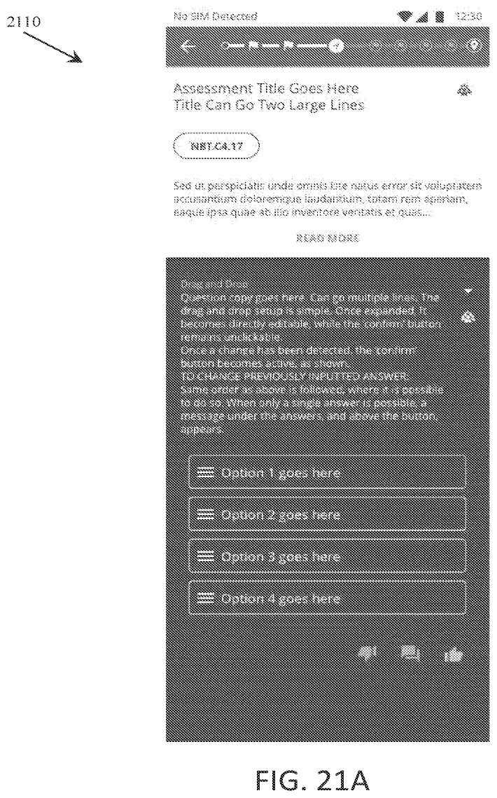

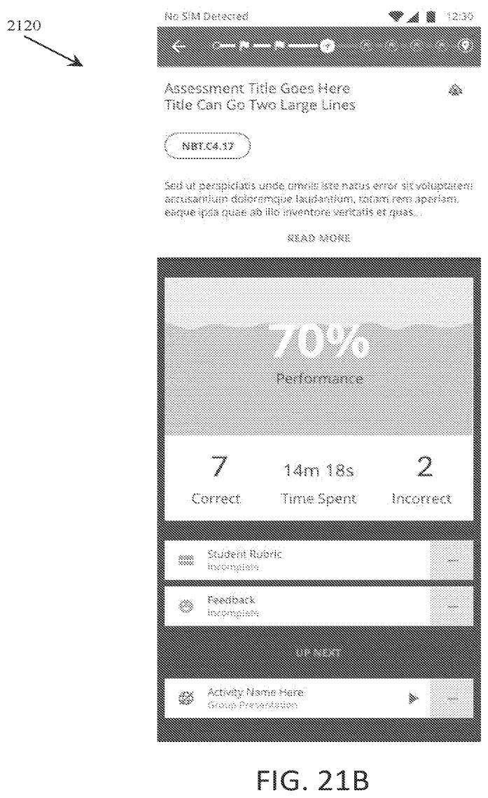

FIG. 20 shows a user interface 2000 for providing feedback related to a learning experience, according to an example embodiment. FIGS. 21A and 21B show user interfaces 2110 and 2120 for providing an assessment of concept proficiency, according to an example embodiment.

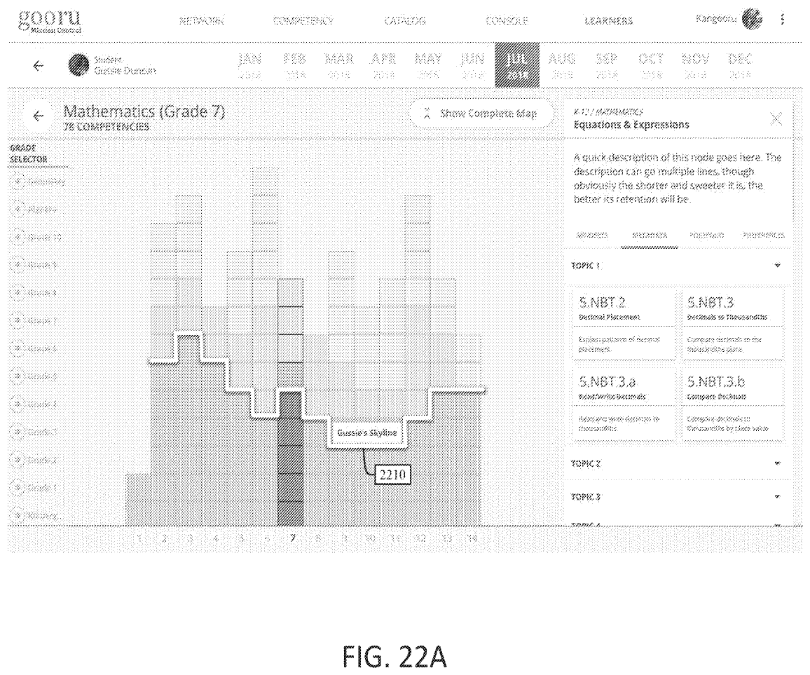

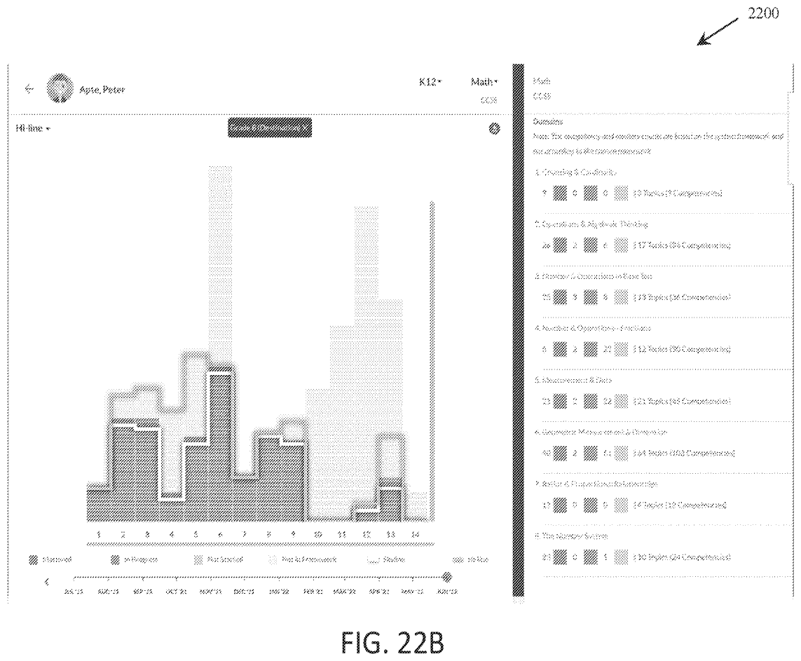

FIGS. 22A and 22B show user interfaces (including interface 2200) for displaying complete competency proficiencies for subjects with student's mastery of the relevant competencies, according to an example embodiment. In particular embodiments, the interfaces of

FIGS. 22A, 22B may include a domain view, where domains in a subject may be displayed along the x-axis and all the competencies may be displayed in a domain along the y-axis as individual cells stacked one above the other. Different appearances such as colors may be used to indicate a learner's mastery of the competencies. For example, (1) gray may indicate that there is no evidence of any learning related to the competency; (2) light blue may indicate that there is evidence that student is studying and learning activities related to the competency, but there is no evidence of the student having mastered it; and (3) dark blue may indicate that the student has studied activities for that competency and there is evidence that the student has mastered the competency.

A skyline for a subject may indicate the extent to which the student has mastered any given domain. The skyline may be plotted on the domain view and can be turned on or off. The highest competencies in each domain that have evidence of mastery are connected together with a line to indicate the skyline. A snapshot of the competency proficiency chart can be created for any given time period and a series of these views provides the learner's progress through the competencies in the subject.

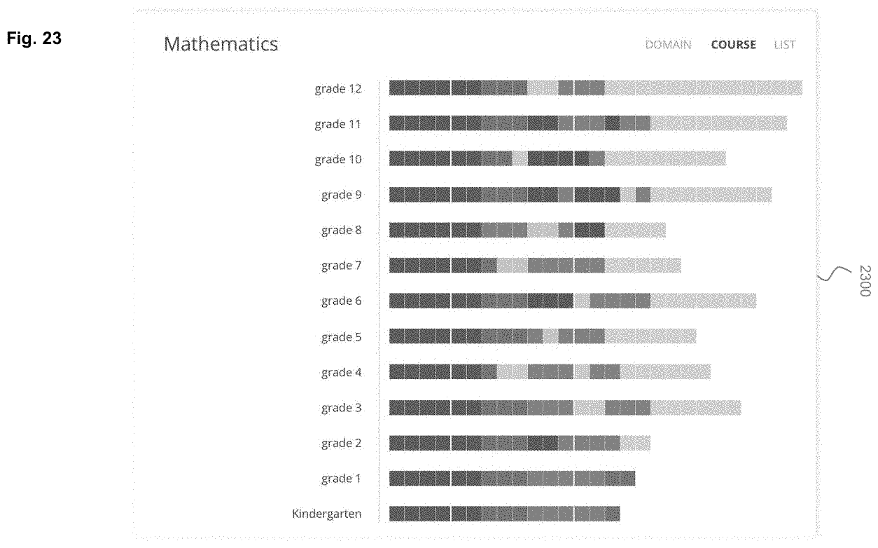

FIG. 23 illustrates a user interface 2300 showing a course view displaying the complete competency proficiency for a subject with student's mastery of the competencies by taxonomy course, according to an example embodiment. The taxonomy courses in a subject are displayed along the y-axis with all the competencies covered in that course along the x-axis as individual cells stacked one next to the other. Again, colors may be used to indicate learner's mastery of the competencies.

A snapshot of the competency proficiency chart may be created for any given time period and a series of these views provides the learner's progress through the competencies in the subject by course.

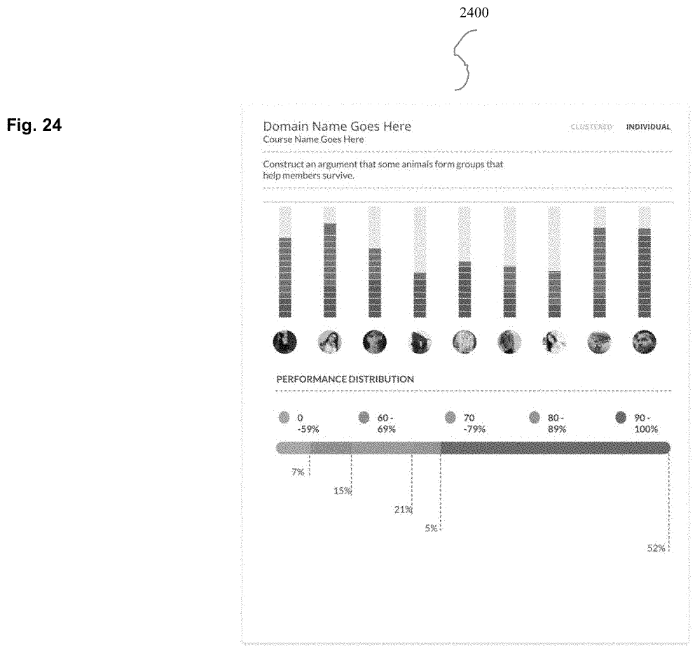

FIG. 24 illustrates a user interface 2400 showing a comparative view of domain proficiency in a cohort of learners, according to an example embodiment. Interface 2400 displays the competency profile for a domain for each learner in a cohort side-by-side. Interface 2400 also displays the average performance distribution for the cohort for the competencies covered in the domain.

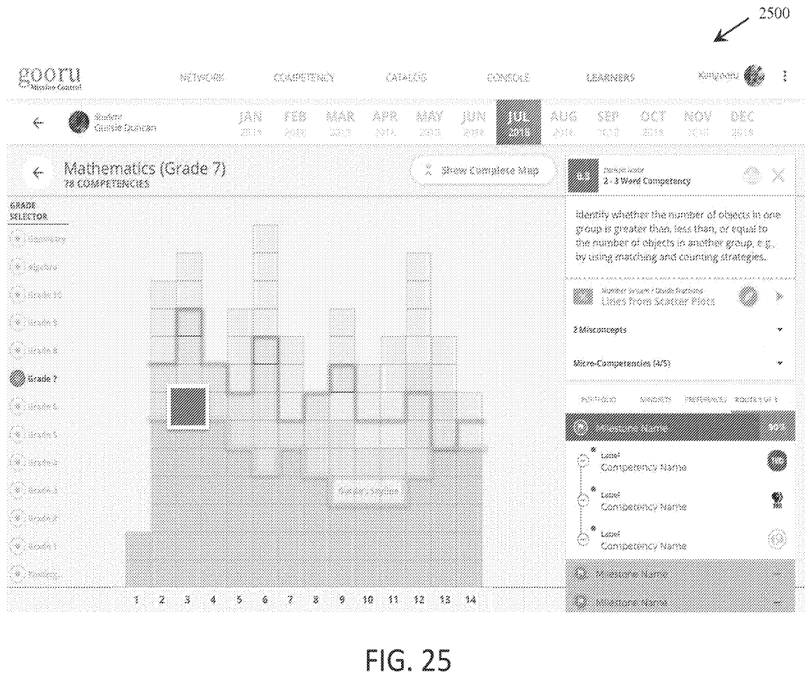

FIG. 25 shows a user interface 2500 presenting information that may be used in providing a suggested route for target destination competency for a learner, according to an example embodiment. Based on a learner's competency profile, the system can provide a suggested learning path for any target competency that the learner wants to master. The system computes the learning path based on the student's proficiency to identify the competencies that the learner would need to study, and master, to be able to master the target competency. This computed path is called the suggested learning path. The learning path is a series of lessons comprising of learning activities that are suggested based on the student's profile. For each competency in the suggested route, the list of activities are shown in the pullout on the right.

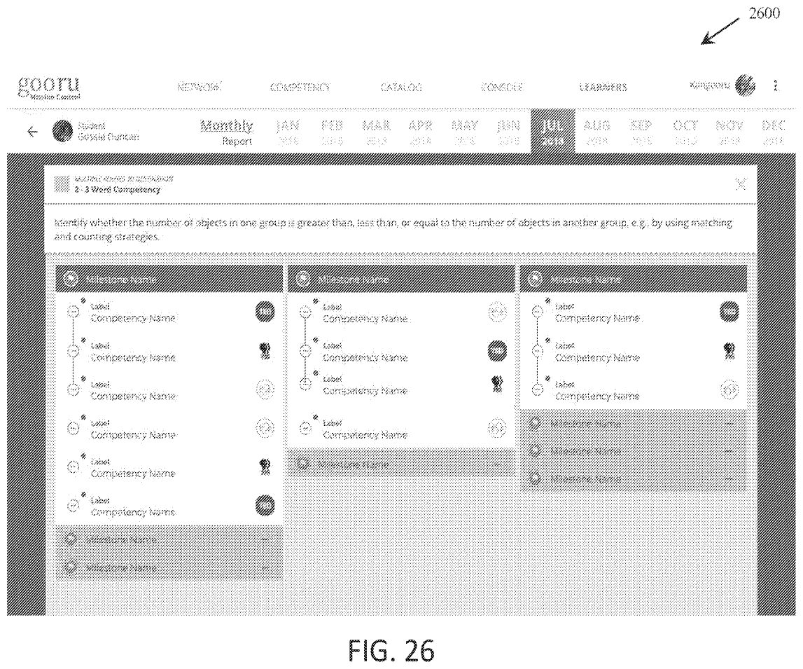

FIG. 26 illustrates a user interface 2600 for providing reroute suggestions, according to an example embodiment. Based on a learner's performance in any competency that the learner is studying, the system may provide a suggestion as the learner goes through the learning activities.

FIG. 26 shows a list of possible suggestions that can be made to the learner for the selected competency that is under study.

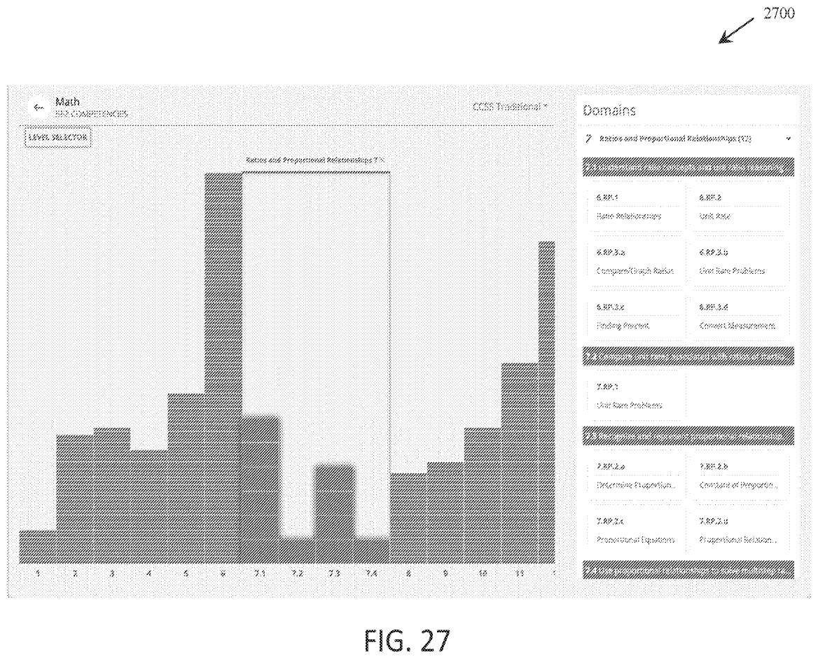

FIG. 27 shows a view 2700 of a competency model for a subject, according to an example embodiment. The view of the competency model for any subject may display the taxonomy of courses along the y-axis and the domains along x-axis. The xy-plane has all the competencies in the subject. Each cell represents a list of competencies that are applicable for a given domain and taxonomy course.

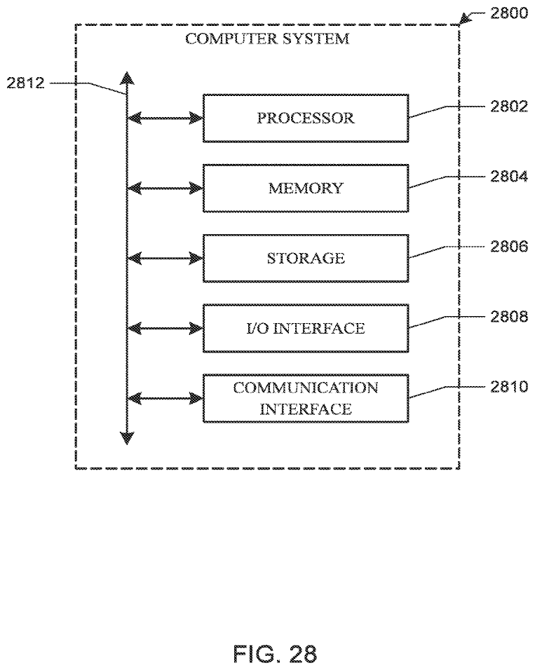

FIG. 28 illustrates an example computer system 2800 with which aspects of the disclosed systems may be realized. In particular embodiments, one or more computer systems 2800 perform one or more steps of one or more methods described or illustrated herein. In particular embodiments, one or more computer systems 2800 provide functionality described or illustrated herein. In particular embodiments, software running on one or more computer systems 2800 performs one or more steps of one or more methods described or illustrated herein or provides functionality described or illustrated herein. Particular embodiments include one or more portions of one or more computer systems 2800. Herein, reference to a computer system may encompass a computing device, and vice versa, where appropriate. Moreover, reference to a computer system may encompass one or more computer systems, where appropriate.

This disclosure contemplates any suitable number of computer systems 2800. Further, this disclosure contemplates computer system 2800 taking any suitable physical form. As example, computer system 2800 may be an embedded computer system, a desktop computer system, a laptop or notebook computer system, a mainframe, a mobile telephone, a personal digital assistant (PDA), a server, a tablet computer system, or a combination of two or more of these. Where appropriate, computer system 2800 may include one or more computer systems 2800; be unitary or distributed; span multiple locations; span multiple machines; span multiple data centers; or reside in a cloud, which may include one or more cloud components in one or more networks. Where appropriate, one or more computer systems 2800 may perform without substantial spatial or temporal limitation one or more steps of one or more methods described or illustrated herein. As an example, one or more computer systems 2800 may perform in real time or in batch mode one or more steps of one or more methods described or illustrated herein. One or more computer systems 2800 may perform at different times or at different locations one or more steps of one or more methods described or illustrated herein, where appropriate. In particular embodiments, computer system 2800 includes a processor 2802, memory 2804, storage 2806, an input/output (I/O) interface 2808, a communication interface 2810, and a bus 2812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 2802 includes hardware for executing instructions, such as those making up a computer program. As an example, to execute instructions, processor 2802 may retrieve (or fetch) the instructions from an internal register, an internal cache, memory 2804, or storage 2806; decode and execute them; and then write one or more results to an internal register, an internal cache, memory 2804, or storage 2806. In particular embodiments, processor 2802 may include one or more internal caches for data, instructions, or addresses. This disclosure contemplates processor 2802 including any suitable number of any suitable internal caches, where appropriate. In particular embodiments, processor 2802 may include one or more internal registers for data, instructions, or addresses. This disclosure contemplates processor 2802 including any suitable number of any suitable internal registers, where appropriate. Where appropriate, processor 2802 may include one or more arithmetic logic units (ALUs); be a multi-core processor; or include one or more processors 2802. Although this disclosure describes and illustrates a particular processor, this disclosure contemplates any suitable processor.

In particular embodiments, memory 2804 includes main memory for storing instructions for processor 2802 to execute or data for processor 2802 to operate on. As an example, computer system 2800 may load instructions from storage 2806 or another source (such as, for example, another computer system 2800) to memory 2804. Processor 2802 may then load the instructions from memory 2804 to an internal register or internal cache. To execute the instructions, processor 2802 may retrieve the instructions from the internal register or internal cache and decode them. During or after execution of the instructions, processor 2802 may write one or more results (which may be intermediate or final results) to the internal register or internal cache. Processor 2802 may then write one or more of those results to memory 2804. In particular embodiments, processor 2802 executes only instructions in one or more internal registers or internal caches or in memory 2804 (as opposed to storage 2806 or elsewhere) and operates only on data in one or more internal registers or internal caches or in memory 2804 (as opposed to storage 2806 or elsewhere). One or more memory buses (which may each include an address bus and a data bus) may couple processor 2802 to memory 2804. Bus 2812 may include one or more memory buses, as described below. In particular embodiments, memory 2804 includes random access memory (RAM). This RAM may be volatile memory, where appropriate Memory 2804 may include one or more memories 2804, where appropriate. Although this disclosure describes and illustrates particular memory, this disclosure contemplates any suitable memory.

In particular embodiments, storage 2806 includes mass storage for data or instructions. As an example, storage 2806 may include a hard disk drive (HDD), a floppy disk drive, flash memory, an optical disc, a magneto-optical disc, magnetic tape, or a Universal Serial Bus (USB) drive or a combination of two or more of these. Storage 2806 may include removable or non-removable (or fixed) media, where appropriate. Storage 2806 may be internal or external to computer system 2800, where appropriate. In particular embodiments, storage 2806 is non-volatile, solid-state memory. In particular embodiments, storage 2806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2806 taking any suitable physical form. Storage 2806 may include one or more storage control units facilitating communication between processor 2802 and storage 2806, where appropriate. Where appropriate, storage 2806 may include one or more storages 2806. Although this disclosure describes and illustrates particular storage, this disclosure contemplates any suitable storage.

In particular embodiments, I/O interface 2808 includes hardware, software, or both, providing one or more interfaces for communication between computer system 2800 and one or more I/O devices. Computer system 2800 may include one or more of these I/O devices, where appropriate. One or more of these I/O devices may enable communication between a person and computer system 2800. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2808 for them. Where appropriate, I/O interface 2808 may include one or more device or software drivers enabling processor 2802 to drive one or more of these I/O devices. I/O interface 2808 may include one or more I/O interfaces 2808, where appropriate. Although this disclosure describes and illustrates a particular I/O interface, this disclosure contemplates any suitable I/O interface.

In particular embodiments, communication interface 2810 includes hardware, software, or both providing one or more interfaces for communication (such as, for example, packet-based communication) between computer system 2800 and one or more other computer systems 2800 or one or more networks. As an example, communication interface 2810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2810 for it. As an example, computer system 2800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2800 may include any suitable communication interface 2810 for any of these networks, where appropriate. Communication interface 2810 may include one or more communication interfaces 2810, where appropriate.

Although this disclosure describes and illustrates a particular communication interface, this disclosure contemplates any suitable communication interface.

In particular embodiments, bus 2812 includes hardware, software, or both coupling components of computer system 2800 to each other. As an example, bus 2812 may include an Accelerated Graphics Port (AGP) or other graphics bus, an Enhanced Industry Standard

Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2812 may include one or more buses 2812, where appropriate. Although this disclosure describes and illustrates a particular bus, this disclosure contemplates any suitable bus or interconnect.

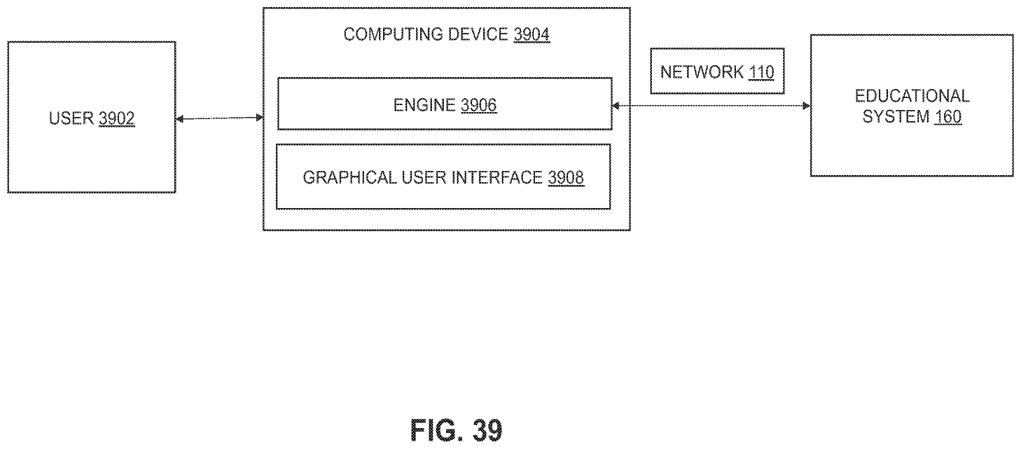

Herein, a computer-readable non-transitory storage medium or media may include one or more semiconductor-based or other integrated circuits (ICs) such as for example, field-programmable gate arrays (FPGAs) or application-specific ICs (ASICs), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate. FIG. 39 depicts another system diagram, according to at least some embodiments described herein. As shown in FIG. 39, a user 3902 (e.g., a learner) may interact with a computing device 3904. The computing device 3904 may be a computer, a laptop computer, a smartphone, and/or a tablet, among other examples not explicitly listed herein. The computing device 3904 may include, among other components, a graphical user interface (GUI) 3908 and an engine 3906 (or a “Navigator engine”). The engine 3906 may allow the user 3902 to interact with the educational system 160 over the network 110.

The engine 3906 includes one or more algorithms. In some implementations, the engine 3906 is built on top of open source packages and includes several custom/proprietary algorithms using one or more of the packages. For example, the engine 3906 includes at least one proprietary artificial intelligence (AI)/machine learning (ML) algorithm built using different packages, such as Py NLTK, T-SNE Projection Plots, sklearn, keras, Label Encoders, Bayesian Tracing, Neural Network, Elbow Method/K-means Clustering, Dqn, Latent Dirichlet Allocation, Glove, Stanford NLP, word2vec, etc. In general, the engine 3906 utilizes the one or more algorithms to: (1) “aggregate” data, (2) “locate” learners for their proficiency, preference, and portfolio, (3) “curate” learning activities, (4) “mediate” learning pathways with recommendations for all stakeholders, and (5) facilitate learning with a number of tools for students and teachers.

Moreover, as previously described herein, a search bar, in addition to standard search techniques based on keywords provided by the user, may leverage the competency model and learner identity. The engine 3906 uses proprietary algorithms that use the competency alignment of the keywords, Learner Identity attributes, Skyline proximity, and learner preferences to recommend the most appropriate learning content based on their relevance, engagement and efficacy attributes.

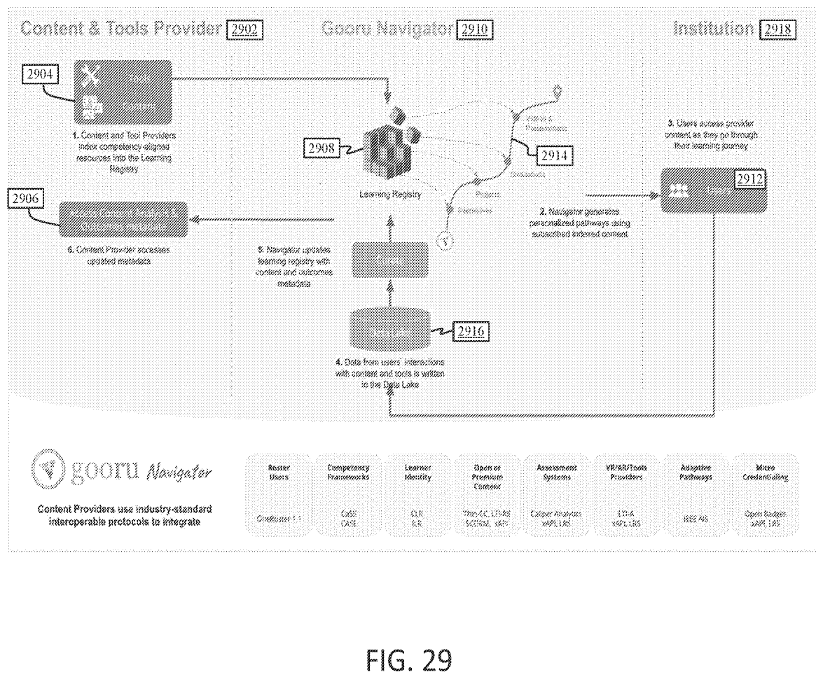

Further, the engine 3906 uses multiple attributes of the user's Learner Identity such as proficiency in competency (Skyline), portfolio, preferences for content types such as video, audio, text, interactives, projects, etc. to make recommendations to the educational system 160 for what content to present and suggest to the user. The engine 3906 then matches it using content metadata, such as competency alignment, keywords, editorial tag, and efficacy metadata, such as relevance, engagement, and efficacy values to suggest relevant results for the user's search term. The engine 3906 also utilizes a proprietary search scoring and ranking algorithm, built on top of ElasticSearch, that serves as the multivariate optimization approach. In addition, FIG. 29 depicts a schematic diagram of the interactions between third-party content and tools 2902 provider, the navigator engine 2910 and the institution 2918, according to at least some embodiments disclosed herein. As shown in FIG. 29, the navigator engine 2910 implements a Learning Registry 2908 that registers content, products, and tools that an institution such as a school may deploy. The data from these products and tools are ingested into a Data Lake 2916 via both interoperable and custom APIs. The data from these products are then cleaned, normalized and transformed using custom code and are used to compute Learner Identity attributes and curate content using proprietary AI/ML algorithms executed by the navigator engine 2910.

Specifically, the third-party content and tools 2902 includes both activities 2904 and tools 2906 and indexes and competency aligns content in the Learning Registry 2908. Further, the Learning Registry 2908 configures the tools 2906 to use interoperability protocols and write into the Data Lake 2916. The navigator engine 2910 computers a location of the learner 2912 and generates adaptive pathways 2914 using open and premium content. Next, the learner 2912 accesses appropriate provider resources and goes through the learning journey. The data from the learners 2912 interactions with content and tools is written to the Data Lake 2916. The navigator engine 2910 then updates the Learning Registry 2908 with content and outcome metadata.

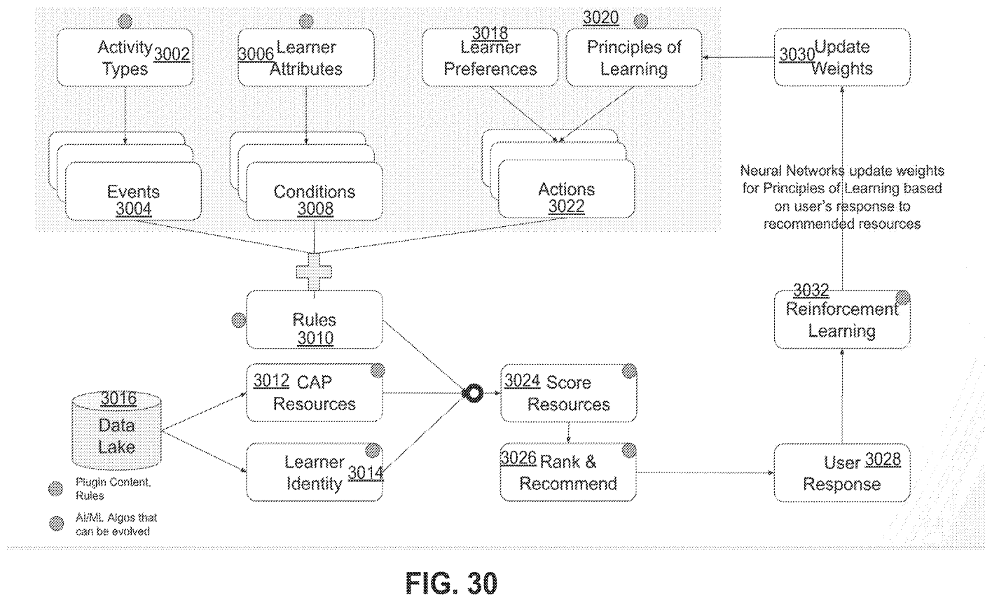

FIG. 30 depicts a schematic diagram depicting how route planning occurs to move the user from a current competency to a desired competency, according to at least some embodiments disclosed herein. As shown in FIG. 30, the engine (e.g., the navigator engine 2910) maps the subject to a competency space and defines markers (also called “Hi-lines”) for the different destinations in that competency space. Then, the engine (e.g., the navigator engine 2910) computes the Learner's location (called the “Skyline”) in the competency space using various methods, such as assertion, diagnostic, or based on data from external tools that a given school may be using. The student/learner chooses a marker as their destination (e.g., “Hi-line”). Both the Skyline and Hi-line are polylines and the engine (e.g., the navigator engine 2910) then computes, using algebraic methods, the route of all competencies between the user's Skyline and Hi-line. For each competency in the route, the engine (e.g., the navigator engine 2910) then uses the recommendation algorithm to finds lessons that are appropriate for the learner based on their Learner Identity attributes, and presents the route to the user/learner. As the user/learner begins to study, the engine (e.g., the navigator engine 2910) captures data about the user's interaction with the content, computes time-spent and performance scores in assessments.

It should be appreciated that the engine (e.g., the navigator engine 2910) implements a reroute recommendation algorithm based on ECpA rules. As described herein, “ECpA” stands for [E]vent, [C]ondition, [p]rinciple of Learning and [A]ction. Each activity (e.g., activity types 3002) produces multiple events 3004. The learner attributes 3006 contribute to the conditions 3008. ECpA rules are defined for the events 3004, the conditions 3008, and applicable principles of learning 3020. Each ECpA rule identifies one or more actions 3022 that is informed by principles of learning 3020 for the user, as well as learner preferences 3018.

The engine (e.g., the navigator engine 2910) defines several rules 3010 based on the various activities 3002. Each rule 3010 has a weight that is based on the principle of learning 3020 that is updated based on data from all users. For a given activity for a learner, the applicable rules based on the user's learner identity 3014 are identified and the search algorithm identifies the appropriate resources (e.g., CAP resources 3012 and/or score resources 3024), factoring in the learner's preferences 3018 and other attributes from the data lake 3016.

A scoring and ranking algorithm 3026 then presents the learner with an ordered list of resources that the user/learner can choose from to enhance their understanding of the concept under study. These recommendations reroute the user/learner from their original path. Once the user/learner completes studying the recommended activity, the engine (e.g., the navigator engine 2910) reroutes the user/leaner back to the main path to study the next competency in the journey. Based on the user's response 3028 to the recommendations, the weights 3030 for the rules are adjusted using reinforcement learning techniques 3032. It should be appreciated that the reinforcement learning algorithm is a proprietary ML algorithm that is implemented by the engine (e.g., the navigator engine 2910) using several AI/ML techniques.

As described herein, the engine (e.g., the navigator engine 2910) allows for “navigated learning” that locates every learner comprehensively and with precision by aggregating data across all content, tools, and services, uses AI to operationalize science of learning and engages the community of parents, teachers, and leadership with real-time actionable insights, so they can coordinate their support of the learner. “Navigated Learning” of the engine (e.g., the navigator engine 2910) assures accelerated learning gains for every learner by: (1) providing a comprehensive learning data backbone that tackles the systemic complexity of learning, (2) a “Navigated Learning Collaborative (NLC)” that engages the entire ecosystem to support diverse learners, (3) enabling the integration of research with practice to accelerate learning outcomes for everyone, and (4) providing trusted operations with strong governance about data ownership, user privacy, data security, accessibility, community engagement, and complete interoperability.

It should be appreciated that the engine (e.g., the navigator engine 2910) further provides a comprehensive personalized learning solution that uses real-time data with curated open and premium resources to provide a “Google Maps” for learning to support life-long learning. The engine (e.g., the navigator engine 2910) dynamically aggregates data for every competency across subjects from different sources using industry-standard interoperable protocols and provides an adaptive pathway of learning activities from different content and tool providers designed to support progress, enrichment, and intervention.

The engine (e.g., the navigator engine 2910) further supports teachers, parents, and school leaders with tools that provide real-time actionable insights. For example, a school can engage the engine (e.g., the navigator engine 2910) and input their current content and tools to optimize learning outcomes for every student by aggregating all available data to locate every learner with precision and across all learning. Then, for their chosen learning goals, students can obtain adaptive pathways of their curriculum and supplementary content from open and premium resource providers to guide them to their destination. The teachers, parents, and leaders use the engine (e.g., the navigator engine 2910) to access real-time dashboards with recommendations provided by engine (e.g., the navigator engine 2910) so that they can coordinate their efforts to support the student.

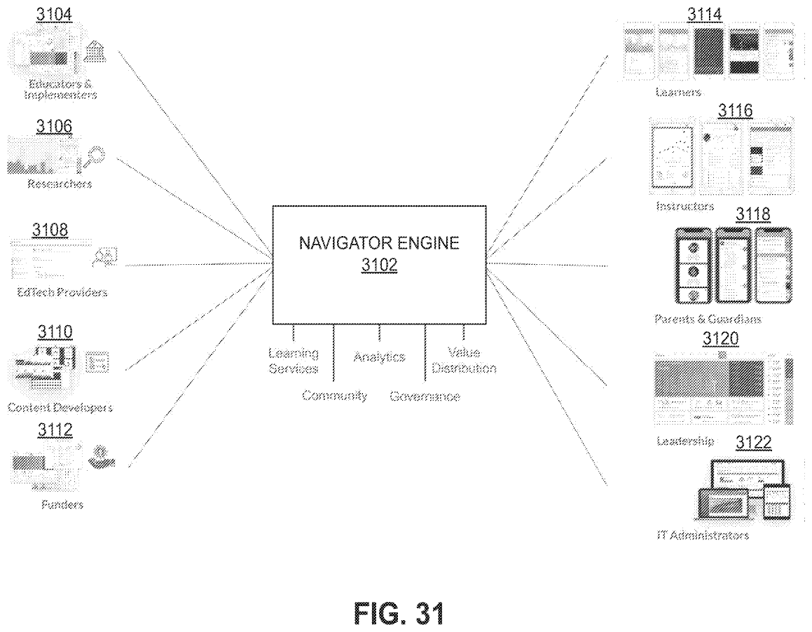

An illustrative diagram of a navigator engine 3102 (or the engine 3102) ecosystem is depicted in FIG. 31, according to at least some embodiments described herein. As shown in FIG. 31, the navigator engine 3102 provides interoperable learning services and supports educators and implementers 3104 (which includes all partners who are responsible for implementing Navigated Learning, including schools, institutions and organizations), researchers 3106 (who develop, evolve, and integrate their expertise in cognitive, behavioral, learning, and neuroscience with the support of data and computer scientists), educational technology providers 3108 (who use APIs and widgets to develop new tools or integrate with their applications to bring the navigator engine 3102 to their cohorts), content developers 3110 (who index their content in the navigator engine 3102 and monitor coverage, usage, and efficacy of the content), and funders 3112 (that include both institutional and individual grantors who get insight into how their grants are transforming learning across different projects that are using their grants). Moreover, learners 3114 are provided an interface for learning and all stakeholders (e.g., instructors 3116, parents and guardians 3118, leadership 3120 and information technology (IT) administrators 3122) have a real-time dashboard executable on the computing device (e.g., the computing device 3904 of FIG. 39).

Further, it should be appreciated that the navigator engine 3102 (or the engine 3102) includes both web and mobile applications. The navigator engine 3102 (or the engine 3102) works alongside a curriculum and tools that are currently used by schools or organizations. The navigator engine 3102 (or the engine 3102) is unique in few key respects to enhance the current practices in any learning environment. For example, the navigator engine 3102 (or the engine 3102) includes a Navigator Competency Model that structures all of the learning space into a progression of competencies. The Navigator Competency Model consists of a competency framework that organizes the competencies into a hierarchy of facet (subject), domain, topic, competency, and micro-competency. Every competency is well defined with micro-competencies, dependencies, alternate conceptions, depth-of-knowledge, and a decay function. The competency model relates learning activities, learner proficiency, and local norms to competencies.

Further, the navigator engine 3102 (or the engine 3102) understands the learner comprehensively and with precision. The navigator engine 3102 (or the engine 3102) also includes a Learner Identity Model that helps locate the learner's Skyline very precisely across various dimensions, including their knowledge in every competency, their SEL, their engagement with the community and their behavior. The navigator engine 3102 captures extensive data as the learner engages with the content and tools. The Learner Identity is computed using AI/ML techniques based on all the data available for the learners from the various content and tools used in practice. This precise understanding of the learner is used to generate adaptive pathways with appropriate and relevant content and to make reroute suggestions based on their performance in specific competencies.

Further, the navigator engine 3102 provides a “GPS experience” for learners. For example, students learn any subject or engage in social-emotional learning, teachers may engage the navigator engine 3102 for professional development, school leadership and School Management Committees (SMCs) can improve their data literacy by learning with the navigator engine 3102, and parents can learn how to better support their children's learning using the navigator engine 3102. For example, the navigator engine 3102 is integrable with open Moodle and open Canvas using LTI to bring LMS capabilities to the personalized learning solution of the navigator engine 3102.

Additionally, the navigator engine 3102 provides real-time evidence of learning to all stakeholders, including: teachers, parents, and school leadership and ecosystem players, such as researchers, content designers, and administrators. Based on the roles and privileges of the leadership, they receive appropriate actionable insights. Further, the navigator engine 3102 offers the software development community open APIs so that they can extend the capabilities of the navigator engine 3102 and/or develop audience-specific applications.

Further, the navigator engine 3102 provides the ability for both OER and premium content providers to register and index their content and tools into the navigator engine 3102 and enables the users to leverage their existing practices and tools to accelerate outcomes. Moreover, as described, the navigator engine 3102 provides an Institution Data Lake (IDL) to aggregate data of their cohorts from across different learning service providers. Partners own all of the data of their cohorts and their administrators control the sharing of their cohort's data with third-party tools for personalization and reporting.

It should be appreciated that the navigator engine 3102 enables transdisciplinary researchers, such as from learning science, data science, cognitive science, neuroscience and psychology to develop, validate and evolve their science with practitioners. The navigator engine 3102 includes a research portal for researchers to use big-data from the practitioners. Additionally, it should be appreciated the navigator engine 3102 is a data backbone that aggregates data from different content, tools and services. Furthermore, the navigator engine 3102 supports industry-standard interoperable protocols such as LTI, xAPI, CASE, Caliper Analytics, Common Cartridge and other IMS and IEEE standards. This makes it “future-proof” as the navigator engine 3102 can incorporate new content and tools that will come into vogue. The navigator engine 3102 includes tools are industry-standards compliant and the components of the navigator engine 3102 can be integrated with any LMS. Additionally, the navigator engine 3102 is WCAG2.1 level A and level AA compliant. Additionally, the navigator engine 3102 is SOC2 compliant and implements robust access control, authentication, data integrity, and content protection both in the hosting infrastructure of its applications and also within the application.

While using the navigator engine 3102, the learners and organizations own their data. Organizations get ownership of their data in their tenancy and have control over systems and users that have access to the data. The navigator engine 3102 implements privacy requirements defined under FERPA and COPPA and further adheres to GDPR compliance requirements. The navigator engine 3102 also provides the users the ability to determine how their data is managed within the navigator engine 3102, determine who has access to their data, and request deletion of data (e.g., “right to be forgotten”).

It should be appreciated that in some implementations, the navigator engine 3102 includes numerous applications for learners, instructors, guardians, leadership, IT admins, curriculum designers, researchers, and developers among edTech providers. For example, the navigator engine 3102 provides at least the following illustrative applications: (1) a “Navigator for Learners” that provides a GPS-like experience that guides students to their grade-level destination with activities appropriate to their unique set of knowledge and skills, (2) a “Navigator for Instructors” that enables teachers to monitor the progress of each student, providing real-time data to help them save time and make data-informed decisions, (3) a “Navigator for Guardians” that provides parents and guardians with real-time updates on their child's progress and gives them access to community support, (4) a “Navigator Mission Control” that provides real-time data to all leaders in a given organization hierarchy so that they can coordinate and scale learning outcomes, (5) a “Navigator Library” that supports curriculum developers with tools to build their competency frameworks and index their content, specify their scope and sequence, and subscribe to existing content and tools from the registry, (6) a “Navigator for Administrators” that enables administrators to white label the navigator, configure it with the organization's curriculum, content and tool preferences, roster their users, and manage the classes and enrollments, (7) a “Navigator for Invivo Research” that enables researchers to validate their innovations, plugin their tools and algorithms into the engine, and request access to cohorts and their data sets for research, and (8) a “Navigator Developer Portal” that provides access to sandbox and APIs that application developers can use to integrate any of the Navigator technology and enhance their applications with Navigated Learning capabilities.

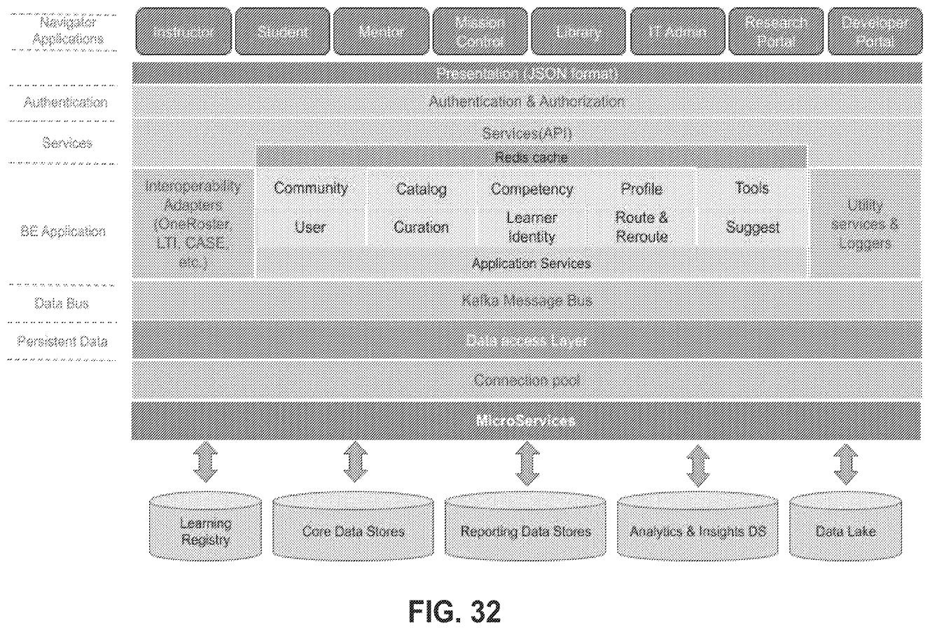

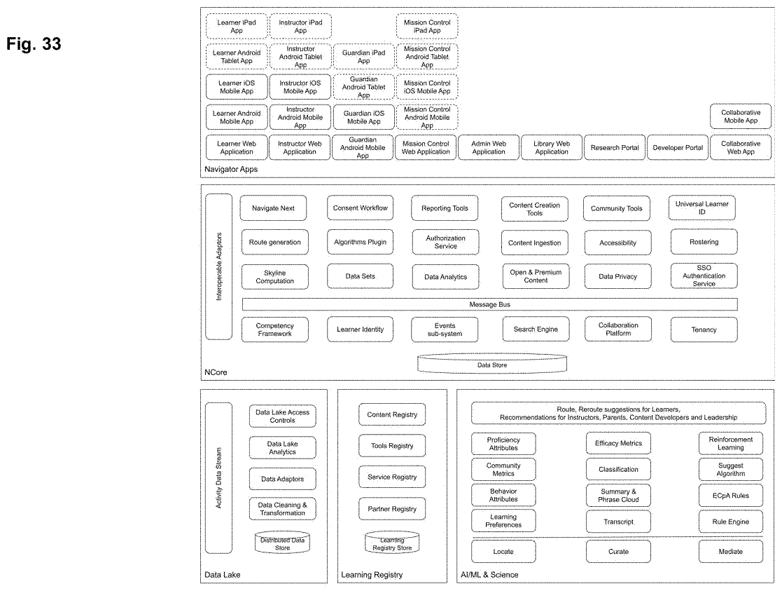

The navigator engine 3102 also implements an event-driven distributed micro-services architecture and is designed for scalability. The navigator engine 3102 is open and free, and can be deployed in a partner's environment, if needed. Such implementation is shown in FIG. 32 and FIG. 33.

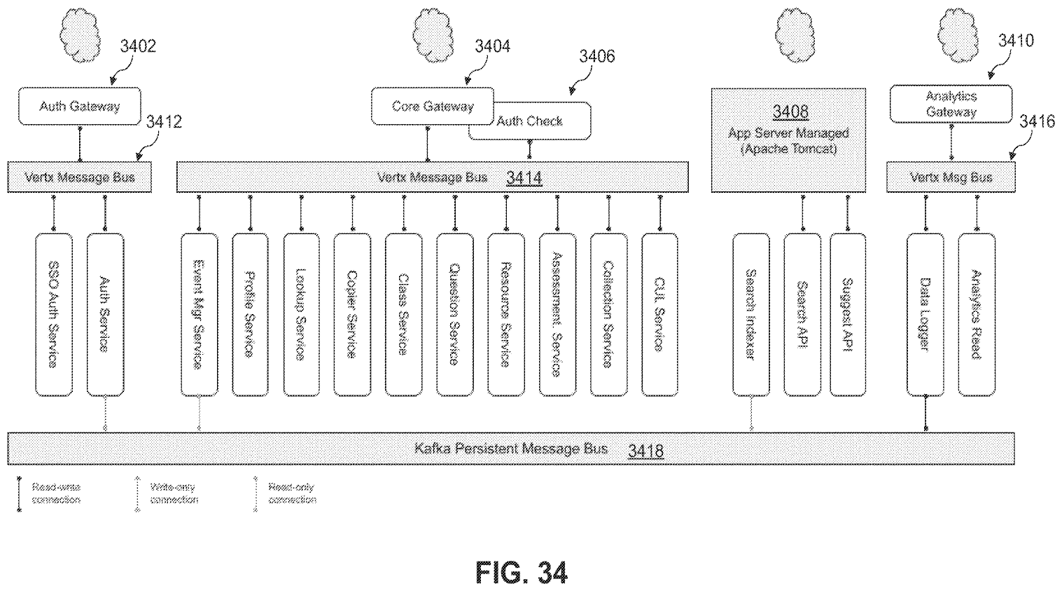

FIG. 34 depicts a schematic diagram of Navigator Core, according to at least some embodiments disclosed herein. Navigator Core is a conglomeration of microservices created using Eclipse Vert.x, which is a polyglot event-driven application framework. The navigator engine 3102 uses separation of concerns (SoC) as a design principle to achieve modularity. The microservices are functional nodes. Each microservice encapsulates specific functions and access is provided using core interfaces. There is minimal functional overlap across the microservices. Further, the navigator engine 3102 implements a layered architecture where data stores are central and abstracted to external layers. The core layer is responsible for data management, provides data level CRUD capability as API and manages user, content, class and usage data.

Orchestrators extend the core capabilities. Specifically, FIG. 34 depicts an authentication gateway 3402, a core gateway 3404, an authentication check 3406, an application server 3408, an analytics gateway 3410, a first Vertx message bus 3412, a second Vertx message bus 3414, a third Vertx message bus 3416, and a Kafka persistent message bus 3418, among other components.

It should be appreciated that Postgres is the primary data store for all engine components and services, including User Management, Content Management, Learning Journeys, Reporting, and Analytics and Insights Generation using AI/ML. The Data Lake described herein enables the capture and storage of raw events of all the learning activities of the users across different learning tools and platforms including the navigator engine 3102. All services are exposed over

Restful API. The API access is authenticated and RBAC provided for authorization of APIs. Kafka forms the core messaging system of the navigator engine 3102 and enables different types of communication between different nodes of the navigator engine 3102 and messaging across clustered sub-systems/microservices. Search and suggest subsystems are based on ElasticSearch. Navigator Core integrates with external Learning Tools, Learning Management Systems (LMSes) and Learning Record Stores (LRSes) to exchange information using the Interoperable Adapters and various Data Exchange Standards.

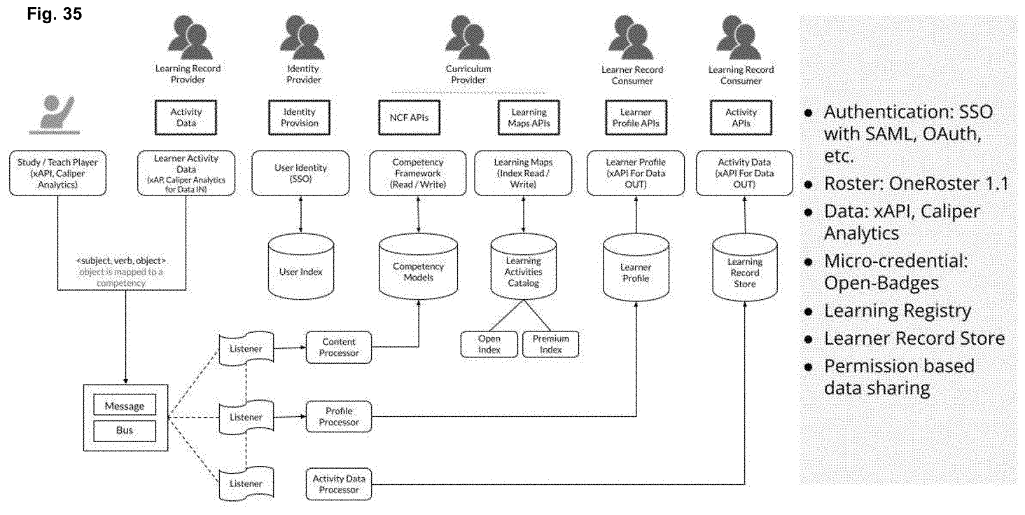

FIG. 35 depicts a schematic diagram of the system set up as a scalable and a high availability (HA) cluster, according to at least some embodiments disclosed herein. The system of FIG. 35 is designed to be horizontally scalable. To achieve this, most core components are built using async reactive framework. This allows blocking operations to be delegated to downstream components, serving the business logic, while the upstream components, like the gateway depicted, is available to accept user requests.

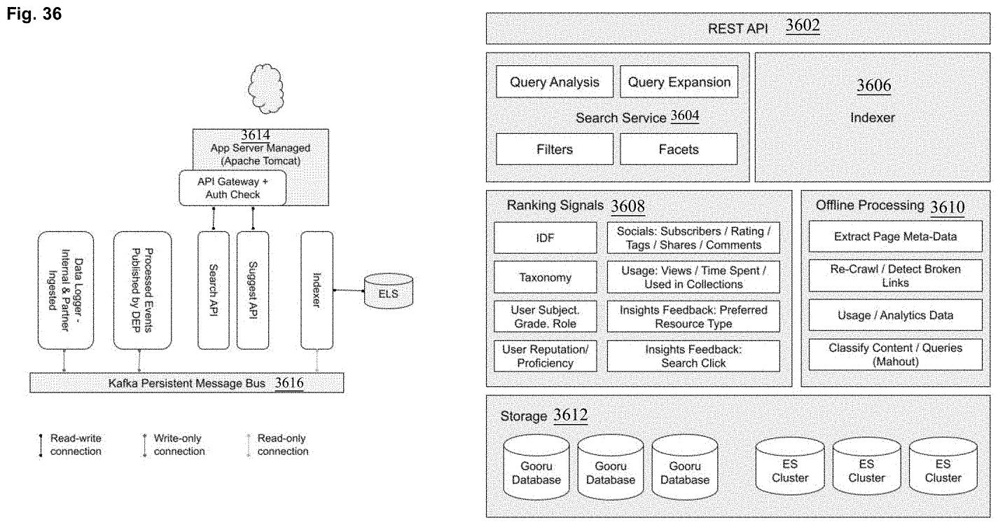

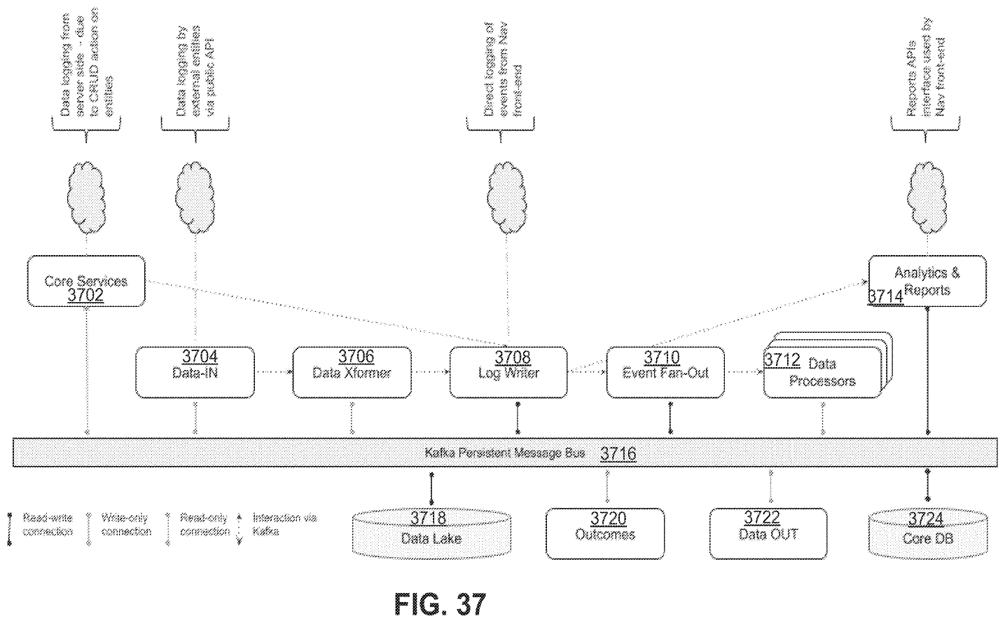

Moreover, as described herein and shown in FIG. 36 and FIG. 37, the search engine has ElasticSearch at its core. All catalog items at index with metadata are stored as terms for faster search. As content gets created or updated, core services publish these changes to Kafka message bus 3616 of FIG. 36 or 3716 of FIG. 37 from where the indexer component refreshes the index attributes across all the ElasticSearch indexes. The search engine utilizes various data points, including: user inputs, usage data gathered, content extracted metadata and other contextual information to serve response for that context. Requests go through a processing pipeline to classify, expand, rewrite, apply necessary filters, search, rank using signals, and personalize. A relevance score of content is computed based on Term Frequency (TF) and Inverse Document

Frequency (IDF) and is adjusted, by the navigator engine 3102, based on usage signals collected by the navigator engine 3102.

Further, FIG. 36 also depicts at least the following components: the application server 3614, the rest API 3602, search services 3604 (including query analysis, filters, query expansion, and facets), an indexer 3606, ranking signals 3608 (e.g., IDF, taxonomy, user subject, user grade, user proficiency, social aspects, usage aspects, insight feedback, etc.), offline processing 3610 (including extracting page metadata, recrawling/detecting broken links, classifying content/queries, etc.), and storage 3612 (including databases). Also, FIG. 37 includes at least the following components: core services 3702, data-IN 3704, data transformer 3706, log writer 3708, event fan out 3710, data processors 3712, analytics and reports 3714, data lake 3718, outcomes 3720, data OUT 3722, and core database 3724.

Further, there are a variety of events that generate activity data. Some are events explicitly logged by application/components (client-side events) and some are generated as a side-effect of certain user actions (server-side events). The navigator engine 3102 will store data from external systems based on various learning data interoperability standards like IMS Caliper Analytics, xAPI or customized mutually agreed upon event specifications. The data from the external systems is first be stored into the Data Lake 3718 as raw events and then is further relayed to data transformers and data processing components. Partners and system integrators can send data to the navigator engine 3102 using the Navigator APIs. Partners can send data to the navigator engine 3102as a JSON payload that is xAPI Standards compliant or any mutually agreed upon custom format. The event transformer component will transform the external system messages into the navigator engine 3102 format and relay them down to other event processors and data stores. The event logger service captures, transforms and stores events. Data processors and atomic elements of the Data Analytics Pipeline (DAP) are responsible to process every event and store data into the underlying data store. The processed data is used to serve the partner data out components and the Navigator reporting API's and AI/ML components for analytics and insights.

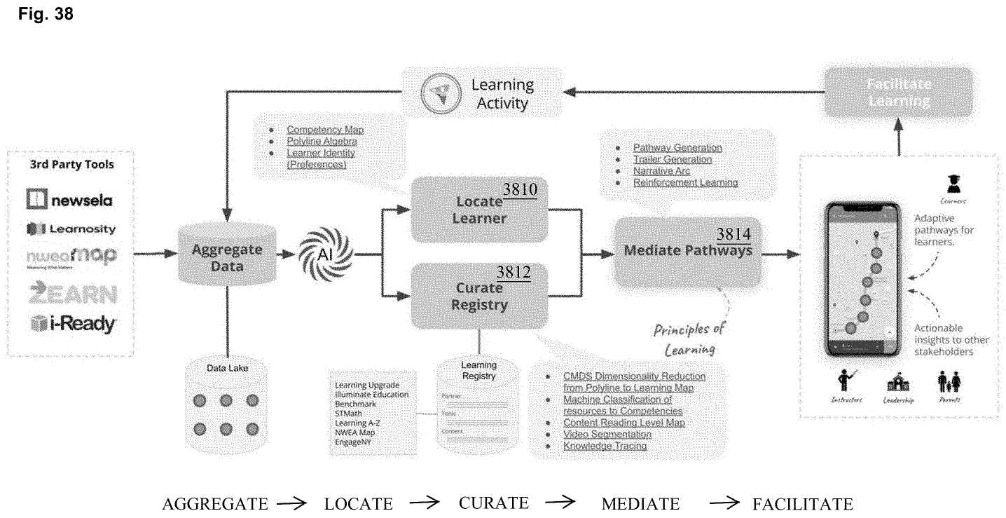

FIG. 38 depicts a schematic diagram associated with a method executed by the system, according to at least some embodiments disclosed herein. The navigator engine 3102 uses big-data to understand learners and learning activities with precision, and generate personalized pathways based on sciences of learning. Personalization starts with the word “person”. The key to personalized learning is to “locate” the learner, i.e. to dynamically update the learner identity, so we always have a complete understanding of the learner's knowledge, mindsets, citizenship, behavior, and preferences. As shown in FIG. 38, a process step 3810 first occurs where the navigator engine 3102 locates learners. Next, the process step 3810 is followed by a process step 3812 where the navigator engine 3102 “curates” or understands every learning activity by using the data stream and content analysis to compute many measures such as competency, use, relevance, engagement and outcomes. Then, the process step 3812 is followed by a process step 3814, where the navigator engine 3102 “mediates” or suggests learning pathways. The navigator engine 3102 uses several AI/ML algorithms to compute various measures for the learner and content. For example, the navigator engine 3102 may use classification, neural networks and deep learning AI techniques, topic modelling techniques like LDA, word embedding models such as word2vec, and document embedding models like Paragraph2Vec to curate the content, SVM, K nearest neighbor clustering, decay functions, Bayesian Knowledge Tracing and other techniques to locate the learner and reinforcement learning to mediate pathways.

As described herein, nonprofits, edTech companies, and educators around the world that span early childhood education, K12 education, higher education, skills training, and professional learning, may leverage the navigation engine with their content and tools to personalize learning for their cohorts and provide actionable insights to other stakeholders. Content, tools and services providers leverage the users on the platform to gain distribution, access the analytics and grow their revenues. These collaborators leverage the navigation engine as a platform to establish a competency model in diverse disciplines, such as K12 subjects, cybersecurity, sewing machine operations, SEL, soft skills and leadership. Collaborators then align their content, activities and tools to competencies. Collaborators roster their users into a white-labeled instance of the navigation engine, where in addition to collaborator's proprietary content and tools, all data from their users and AI-models are owned by the collaborator. Further, content, tools and services providers use the navigation engine to reach millions of learners with their resources, obtain real-time analytics about the efficacy of their resources, and grow their revenues by licensing their premium resources to schools.

Transdisciplinary researchers across cognitive science, neuroscience, learning science, computer science, psychology and data science manifest their innovations as content, tools, algorithms or practices. They integrate their validated innovations with the navigation engine to reach millions of learners. They use consented and anonymized datasets from among millions of users of the navigation engine to validate and evolve the science of learning. Integrating research with practice is central to ensuring that the adaptive pathways and personalized interventions accelerate learning outcomes. Moreover, the navigation engine described herein allows for the fostering of a community of practitioners that interact on separate channels, contribute to and leverage a knowledge base of articles, and participate in questions and answers on discussion forums.

The foregoing descriptions of various embodiments and aspects have been presented for purposes of illustration, but are not intended to be exhaustive or to limit the invention to the embodiments disclosed. Many modifications and variations will be apparent to those of ordinary skill in the art without departing from the scope and spirit of the claimed invention. The terminology used herein was chosen to explain principles of the disclosed embodiments, their practical application, or technical improvements over technologies found in the prior art, or to enable others of ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention, the scope of which is defined by the claims.

What is claimed is:

1. A method executed by a computing device, the computing device comprising one or more processors, one or more memories, and one or more computer-readable hardware storage devices, the one or more computer-readable hardware storage devices containing program code executable by the one or more processors via the one or more memories to implement a method, the method comprising:
receiving, from a user, information associated with the user;
querying a social networking profile of the user to obtain additional information associated with the user;
storing the information and the additional information in a user profile;
receiving subject competency information associated with a degree of study of the user for a learning subject, wherein the subject competency information comprises one or more degrees of study for one or more domains and one or more degrees of study for one or more courses, the domains and courses related to the learning subject, and wherein the subject competency is based on educational standards of a state;
calculating a 3-tuple representing the subject competency information for the user, wherein the 3-tuple comprises a value representing the subject, a value representing the one or more domains, and a value representing the one or more courses;
storing the 3-tuple representation as part of a competency profile associated with the user;
receiving a learning objective associated with the user, the learning objective comprising a 3-tuple of a desired subject competency;
selecting, based on a concept dependency graph, an ordered set of learning activities that establish a path between the subject competency 3-tuple and the learning objective 3-tuple, wherein references to the learning activities are stored in a learning activities table associated with the concepts in the concept dependency graph;
sending information related to the learning activities to the user;
receiving, from the user, an addition of one or more points along the path to create an alternative path;
updating the ordered set of learning activities for the alternative path; and
sending the information related to the learning activities to the user.

2. The method of claim 1, further comprising:
sending the ordered set of learning activities to the user for display in a navigation interface;
receiving a change in the ordered set of learning activities from the user.

3. The method of claim 1, further comprising:
receiving updated subject competency information from the user;
updating the competency profile based on the updated subject competency information; and
sending a new set of ordered learning activities based on the updated competency profile.

4. The method of claim 1, further comprising:
providing one or more assessments associated with one or more of the learning activities; and
providing one or more additional learning activities based on the results of the assessment.

5. The method of claim 1, wherein the navigation interface comprises a map interface displaying the learning activities and the path.

6. The method of claim 1, wherein the learning activities comprise at least one of a text, a video, or an audio recording.

7. The method of claim 1, further comprising:
receiving the concept dependency graph and the learning activities table from a second user.

8. A system comprising:
a memory; and
at least one processor coupled to the memory and configured to:
receive, from a user, information associated with the user;
query a social networking profile of the user to obtain additional information associated with the user;
store the information and the additional information in a user profile;
receive subject competency information associated with a degree of study associated with the user of a learning subject, wherein the subject competency information comprises one or more degrees of study for one or more domains and one or more degrees of study for one or more courses, the domains and courses related to the learning subject, and wherein the subject competency is based on educational standards of a state;
calculate a 3-tuple representing the subject competency information for the user, wherein the 3-tuple comprises a value representing the subject, a value representing the one or more domains, and a value representing the one or more courses;
store the 3-tuple representation as part of a competency profile associated with the user;
receive a learning objective associated with the user, the learning objective comprising a 3-tuple of a desired subject competency;
select, based on a concept dependency graph, an ordered set of learning activities that establish a path between the subject competency 3-tuple and the learning objective 3-tuple, wherein references to the learning activities are stored in a learning activities table associated with the concepts in the concept dependency graph;
send information related to the learning activities to the user;
receive, from the user, an addition of one or more points along the path to create an alternative path;
update the ordered set of learning activities for the alternative path; and
send the information related to the learning activities to the user.

9. The system of claim 8, the at least one processor further configured to:
send the ordered set of learning activities to the user for display in a navigation interface;
receive a change in the ordered set of learning activities from the user.

10. The method of claim 8, the at least one processor further configured to:
receive updated subject competency information from the user;
update the competency profile based on the updated subject competency information; and
send a new set of ordered learning activities based on the updated competency profile.

11. The method of claim 8, the at least one processor further configured to:
provide one or more assessments associated with one or more of the learning activities; and
provide one or more additional learning activities based on the results of the assessment.

12. The method of claim 8, wherein the navigation interface comprises a map interface displaying the learning activities and the path.

13. The method of claim 8, wherein the learning activities comprise at least one of a text, a video, or an audio recording.

14. The method of claim 8, the at least one processor further configured to:
receiving the concept dependency graph and the learning activities table from a second user.

15. A tangible computer-readable device having instructions stored thereon that, when executed by at least one computing device, causes the at least one computing device to perform operations comprising:
receiving, from a user, information associated with the user;
querying a social networking profile of the user to obtain additional information associated with the user;
storing the information and the additional information in a user profile;
receiving subject competency information associated with a degree of study of the user for a learning subject, wherein the subject competency information comprises one or more degrees of study for one or more domains and one or more degrees of study for one or more courses, the domains and courses related to the learning subject, and wherein the subject competency is based on educational standards of a state;
calculating a 3-tuple representing the subject competency information for the user, wherein the 3-tuple comprises a value representing the subject, a value representing the one or more domains, and a value representing the one or more courses;
storing the 3-tuple representation as part of a competency profile associated with the user;
receiving a learning objective associated with the user, the learning objective comprising a 3-tuple of a desired subject competency;
selecting, based on a concept dependency graph, an ordered set of learning activities that establish a path between the subject competency 3-tuple and the learning objective 3-tuple, wherein references to the learning activities are stored in a learning activities table associated with the concepts in the concept dependency graph;
sending information related to the learning activities to the user;
receiving, from the user, an addition of one or more points along the path to create an alternative path;
updating the ordered set of learning activities for the alternative path; and
sending the information related to the learning activities to the user.

16. The computer-readable device of claim 15, the operations further comprising:
sending the ordered set of learning activities to the user for display in a navigation interface;
receiving a change in the ordered set of learning activities from the user.

17. The computer-readable device of claim 15, the operations further comprising:
receiving updated subject competency information from the user;
updating the competency profile based on the updated subject competency information; and
sending a new set of ordered learning activities based on the updated competency profile.

18. The computer-readable device of claim 15, the operations further comprising:
providing one or more assessments associated with one or more of the learning activities; and
providing one or more additional learning activities based on the results of the assessment.

19. The computer-readable device of claim 15, wherein the navigation interface comprises a map interface displaying the learning activities and the path.

20. The computer-readable device of claim 15, wherein the learning activities comprise at least one of a text, a video, or an audio recording.
